(19) United States
(12) Patent Application Publication
(10) Pub. No.: US 2025/0308113 A1
(43) Pub. Date: Oct. 2, 2025

(54) IMAGE RELIGHTING USING MACHINE LEARNING

(71) Applicant: ADOBE INC., SAN JOSE, CA (US)

(72) Inventors: Ambareesh Revanur, San Jose, CA (US); Nicholas Isaac Kolkin, Chicago, IL (US); Dhwanit Agarwal, San Jose, CA (US); Shradha Agrawal, Milpitas, CA (US); He Zhang, San Jose, CA (US); Midhun Harikumar, Sunnyvale, CA (US); Elya Shechtman, Seattle, WA (US)

(21) Appl. No.: 18/949,023

(22) Filed: Nov. 15, 2024

Related U.S. Application Data
(60) Provisional application No. 63/569,897, filed on Mar. 26, 2024.

(51) Int. Cl. G06T 11/60; G06T 11/00

(52) U.S. Cl. CPC G06T 11/60; G06T 11/001

(57) ABSTRACT

A method, apparatus, non-transitory computer readable medium, and system for image generation includes obtaining an input image and an input prompt, where the input image depicts an object and the input prompt describes a lighting condition for the object, generating relighted image features based on the input image and the input prompt, where the relighted image features represent the object with the lighting condition, and generating a synthetic image based on the relighted image features, where the synthetic image depicts the object with the lighting condition.

### CROSS-REFERENCE TO RELATED APPLICATION

This application claims priority under 35 U.S.C. § 119 to U.S. Provisional Application No. 63/569,897, filed on Mar. 26, 2024, in the United States Patent and Trademark Office, the disclosure of which is incorporated by reference herein in its entirety.

### BACKGROUND

The following relates generally to image generation, and more specifically to image relighting. Machine learning algorithms build a model based on sample data, known as training data, to make a prediction or a decision in response to an input without being explicitly programmed to do so. One area of application for machine learning is image generation.

Machine learning models can be used to generate images based on input guidance provided by text or images. Image relighting refers to a process of replacing a lighting condition of an input image with a novel lighting condition in a relighted image.

### SUMMARY

Systems and methods are described for generating a relighted image using a low-rank adaptation layer of an image generation model. In an example, the low-rank adaptation layer efficiently adapts weights of the trained image generation model to perform a relighting task of generating relighted image features for an image element of an input image in a latent space. The relighted image features can be generated based on an input prompt, such as a text prompt or an image prompt, describing a desired lighting condition for the image element. The image generation model then decodes the relighted image features to obtain a relighted image including the image element with lighting according to the desired lighting condition. Furthermore, in some embodiments, the image generation model computes a color transformation function based on the relighted image features, and an image generation system obtains the relighted image by applying a color transformation predicted by the color transformation function to the input image.

By generating an image based on the relighted image features and, in some embodiments, the color transformation function, the image generation model provides a relighted image depicting a relighted image element with more efficiency and accuracy than conventional machine learning models.

Additionally, in some embodiments, the relighted image includes a background generated by the image generation model based on the input prompt. By generating both the relighted image element and the background according to a same input prompt using one model, some aspects of the present disclosure avoid the expense and inefficiency of using at least two machine learning models to accomplish a similar compositing task.

This Summary introduces a selection of concepts in a simplified form that are further described below in the Detailed Description. As such, this Summary is not intended to identify essential features of the claimed subject matter, nor is it intended to be used as an aid in determining the scope of the claimed subject matter.

### BRIEF DESCRIPTION OF THE DRAWINGS

The Detailed Description is described with reference to the accompanying figures. Entities represented in the figures are indicative of one or more entities and thus reference is made interchangeably to single or plural forms of the entities in the discussion.

FIG. 1 shows an example of an image generation system according to aspects of the present disclosure.

FIG. 2 shows an example of a method for image relighting according to aspects of the present disclosure.

FIG. 3 shows an example of an image generation system for generating a relighted image according to aspects of the present disclosure.

FIG. 4 shows an example of an image generation system for generating a synthetic image using a color transformation function according to aspects of the present disclosure.

FIG. 5 shows an example of an image generation system for generating a synthetic image background according to aspects of the present disclosure.

FIG. 6 shows an example of a guided diffusion model according to aspects of the present disclosure.

FIG. 7 shows an example of a U-Net according to aspects of the present disclosure.

FIG. 8 shows an example of a method for generating a synthetic image according to aspects of the present disclosure.

FIG. 9 shows an example of a method for conditional image generation according to aspects of the present disclosure.

FIG. 10 shows an example of a diffusion process according to aspects of the present disclosure.

FIG. 11 shows an example of a method for training an image generation model according to aspects of the present disclosure.

FIG. 12 shows an example of a flow diagram depicting an algorithm as a step-by-step procedure for training a machine learning model according to aspects of the present disclosure.

FIG. 13 shows an example of a method for training a diffusion model according to aspects of the present disclosure.

FIG. 14 shows an example of a computing device according to aspects of the present disclosure.

FIG. 15 shows an example of an image generation apparatus according to aspects of the present disclosure.

### DETAILED DESCRIPTION

### Overview

The following relates to image relighting using machine learning. Image relighting refers to a process of replacing a lighting condition (e.g., a visual characteristic of lighting included in an image) of an input image with a novel lighting condition in a relighted image. Image relighting may be accomplished using image rendering or machine learning processes. However, conventional image rendering processes do not generate accurate relighted images or are inefficient due to a use of specialized and expensive image capturing and rendering hardware and software, while conventional machine learning processes require a full model to be trained to relight a foreground object, and at least two models to be trained to provide an image including a relighted foreground object and a background object. Furthermore, conventional machine learning models that are used to generate image backgrounds tend to suffer from a bias caused by a foreground object, which results in a lack of diversity among the generated backgrounds.

Accordingly, aspects of the present disclosure generate a relighted image by encoding an input image depicting an image element to obtain image features in a latent space, and generating relighted image features using a low-rank adaptation (LoRA) layer of an image generation model based on the image features and a lighting condition described by an input prompt, such as a text prompt or an image prompt. The LoRA layer efficiently adapts weights of the trained image generation model to generate the relighted image features according to the lighting condition. The image generation model then decodes the relighted image features, or in some embodiments applies a color transformation computed by additional color transformation layers based on the relighted image features to the input image, to obtain a relighted image including the image element with lighting according to the desired lighting condition.

By generating the relighted image features using the low-rank adaptation layer, and, in some embodiments, the color transformation function, the image generation model provides a relighted image depicting a relighted image element with more efficiency and accuracy than conventional machine learning models.

Additionally, in some embodiments, the relighted image includes a background generated by the image generation model based on the input prompt (for example, using a diffusion process). In some embodiments, the image generation model generates the background using a second LoRA layer that is trained to generate an image using a reverse diffusion process. By generating both the relighted image element and the background according to a same input prompt, aspects of the present disclosure avoid the expense and inefficiency of training at least two machine learning models to accomplish a similar task and avoid biasing the background with the relighted image element.

An aspect of the present disclosure is used in an image compositing context. For example, a user provides an input image depicting an object (e.g., a basketball) and a text prompt describing an intended setting for the object (e.g., “a floor of a crowded arena”) to an image generation apparatus of the image generation system. The image generation system generates a synthetic image by relighting the basketball included in the input image according to a lighting condition implied by the text prompt and generating a synthetic background at least partially surrounding the object based on content described by the text prompt. As an example result, the synthetic image depicts a basketball resting on a floor of a crowded arena, and the lighting of the basketball causes the basketball to appear to be harmoniously integrated with the background scene.

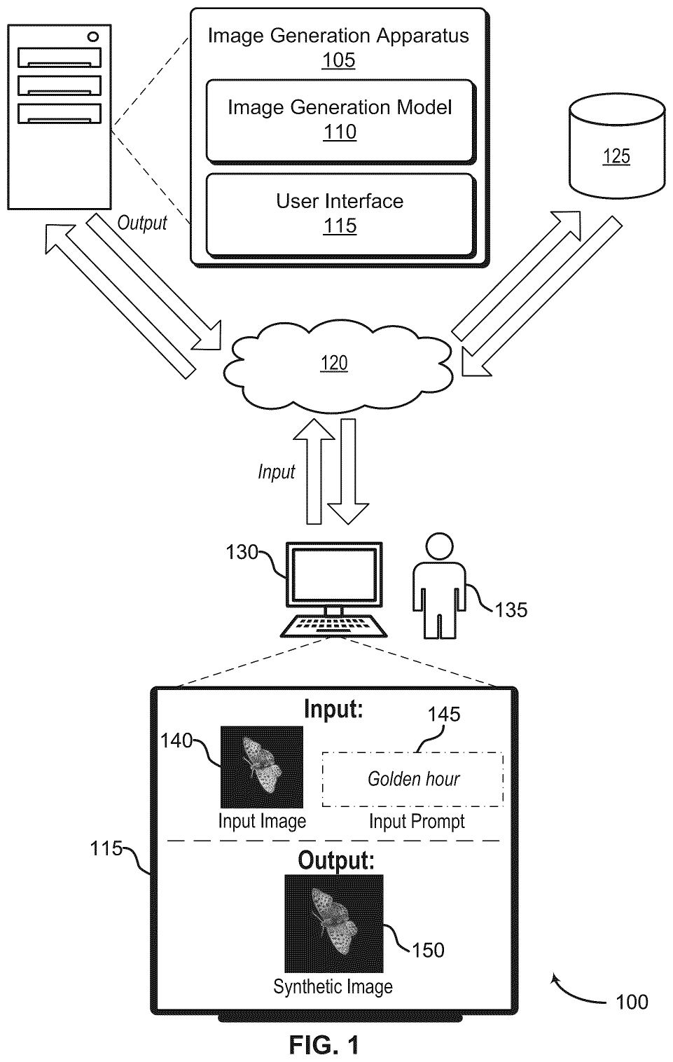

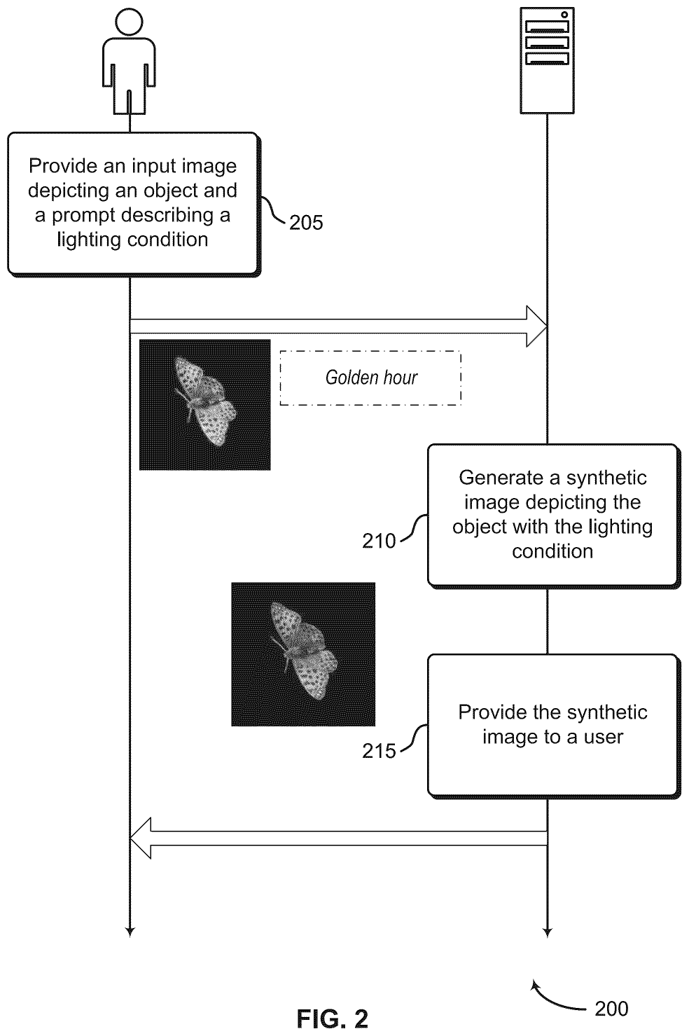

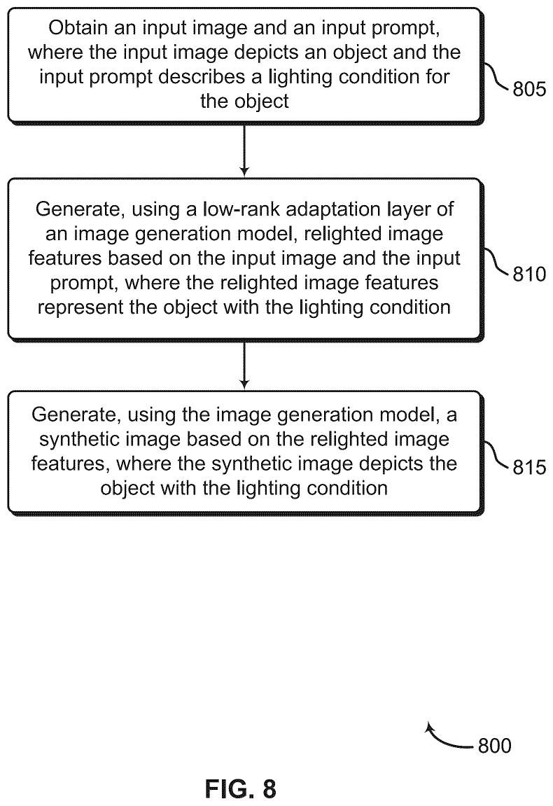

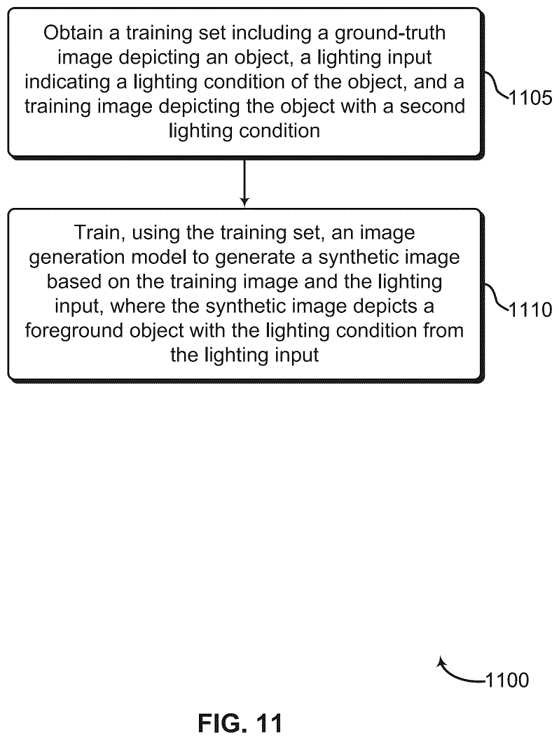

Further example applications of the present disclosure in the image compositing context are provided with reference to FIGS. 1 and 2. Details regarding the architecture of the image generation system are provided with reference to FIGS. 1, 3-7, and 14-15. Examples of a process for image generation are provided with reference to FIGS. 8-10. Examples of a process for training a machine learning model are provided with reference to FIGS. 11-13.

Embodiments of the present disclosure improve upon conventional image generation systems by making an image relighting process more efficient and accurate. For example, some embodiments achieve this efficiency and accuracy by generating relighted image features for an image object using a LoRA layer of an image generation model, where the LoRA layer efficiently adapts weights of a trained image generation model to perform a feature generation process with increased speed, and generating a synthetic image based on the relighted image features, where the synthetic image depicts the image object according to an input lighting condition. By contrast, conventional image rendering processes for image relighting do not generate accurate relighted images or are inefficient due to a use of specialized and expensive image capturing and rendering hardware and software, while conventional machine learning processes for image relighting require a full model to be trained to relight a foreground object.

Furthermore, some embodiments of the present disclosure improve upon conventional image generation systems by efficiently generating a background for the synthetic image according to the lighting condition using an image generation process performed by other layers of the image generation model. In some embodiments, the other layers include one or more additional LoRA layers. By contrast, conventional machine learning processes for image relighting require at least two models to be trained to provide an image including a relighted foreground object and a background object, or require each layer of a machine learning model to be trained to perform both relighting and background functions. Furthermore, in some cases, the one or more low-rank adaptation layers allow a generation bias that might be induced by an image object to be avoided, resulting in synthetic images that depict more diverse background scenes than conventional image generation systems provide.

### Image Generation System

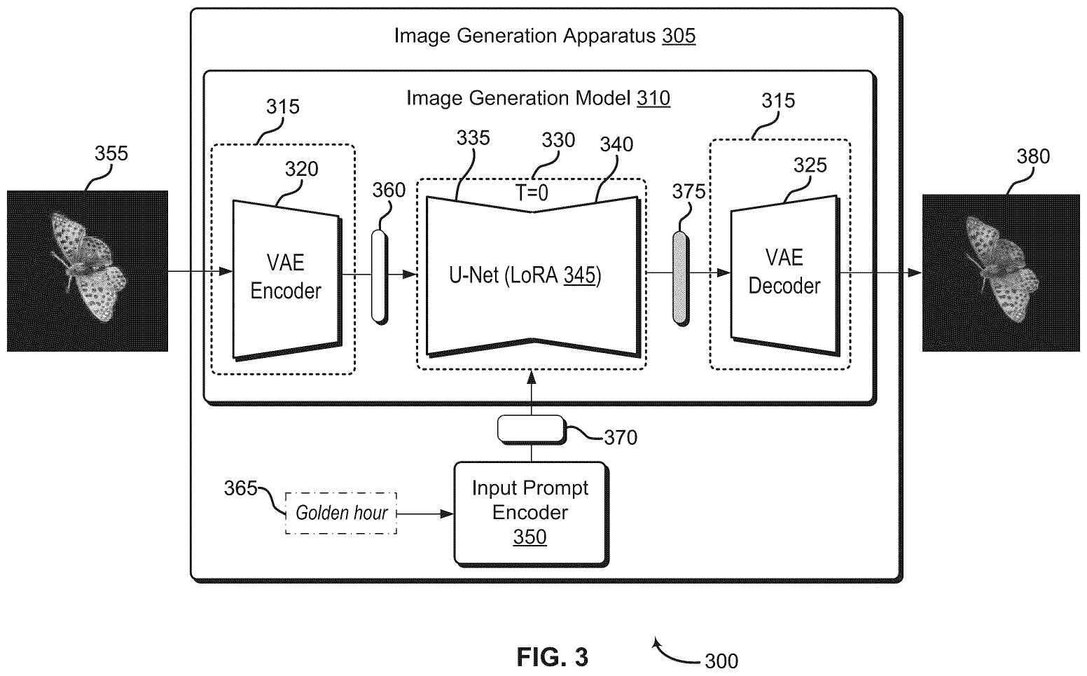

FIG. 1 shows an example of an image generation system 100 according to aspects of the present disclosure. The example shown includes image generation system 100, input image 140, input prompt 145, and synthetic image 150. Image generation system 100 is an example of, or includes aspects of, the corresponding element described with reference to FIGS. 3-5. In one aspect, image generation system 100 includes image generation apparatus 105, cloud 120, database 125, user device 130, and user 135. In one aspect, image generation apparatus 105 includes image generation model 110 and user interface 115.

Referring to FIG. 1, according to some aspects, image generation apparatus 105 obtains an input image (e.g., input image 140) and an input prompt (e.g., input prompt 145). The input image depicts an object and the input prompt describes a lighting condition for the object. In some aspects, the lighting condition describes or implies at least one of a color, a brightness, a shadow, and a reflective property.

For example, input image 140 depicts a butterfly, and input prompt 145 is a text prompt, “Golden hour”, implying a lighting condition of characteristics (e.g., color, brightness, shadow, etc.) associated with a golden hour period of time shortly after sunrise or before sunset. In the example of FIG. 1, user 135 provides input image 140 and input prompt 145 to image generation apparatus 105 via user interface 115 displayed on user device 130 by image generation apparatus 105.

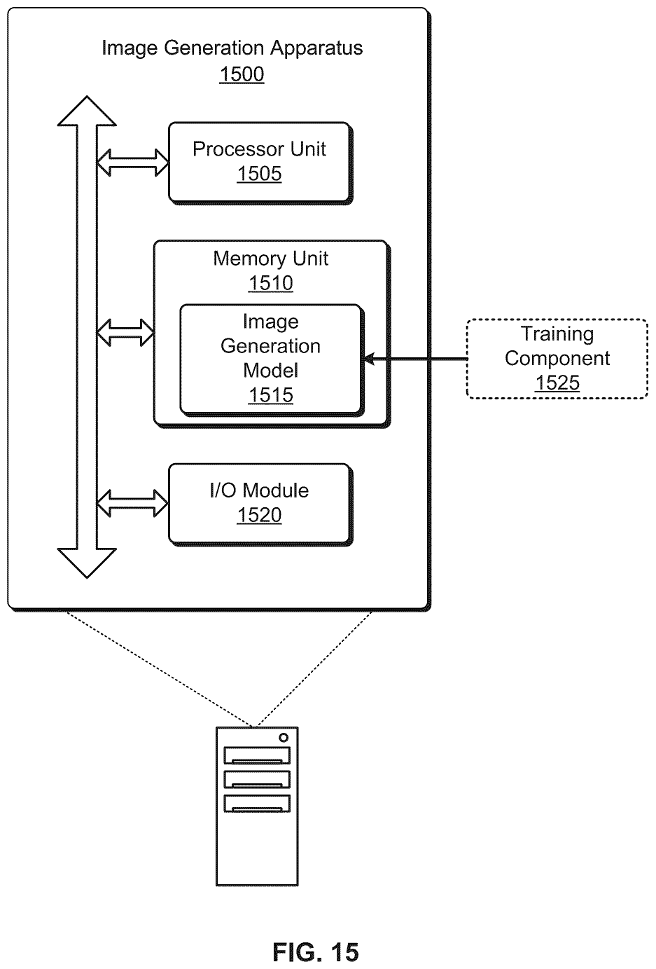

Image generation model 110 generates, using a low-rank adaptation layer of image generation model 110, relighted image features based on the input image and the input prompt. The relighted image features represent the object with the lighting condition. In some aspects, the low-rank adaptation layer includes image relighting parameters stored in a memory component (e.g., memory unit 1510 described with reference to FIG. 15). In some aspects, the image generation model 110 further includes color transformation parameters trained to perform a color transformation function based on the relighted image features.

Image generation model 110 generates a synthetic image (e.g., synthetic image 150) based on the relighted image features. The synthetic image depicts the object with the lighting condition. In an example, synthetic image 150 depicts the butterfly of input image 140 according to the “golden hour” lighting condition described by input prompt 145.

An “input prompt” refers to a text prompt (e.g., a text string) or an image prompt (e.g., an image) used to provide instructive information to a machine learning model. In some cases, for example, a prompt describes an intended lighting condition and/or content of an image to be generated.

A “lighting condition” refers to information for depicting a lighting of an object included in an image. In some cases, for example, apparent lighting of an object is influenced by one or more of a color, a reflectivity, a shadow, etc. of the object. An object “with a lighting condition” is an object that is depicted to have an appearance of being lighted according to the lighting condition.

An “embedding” or “features” refer to a representation of an object (e.g., an element) in a lower-dimensional space (an embedding space) such that semantic information about the object is more easily captured and analyzed by a machine learning model. For example, the embedding is a numerical representation of the object in a continuous vector space (the embedding space) in which objects that include similar semantic information to each other correspond to vectors that are numerically similar and thus “closer” to each other, thereby allowing a similarity between different objects corresponding to different embeddings to be readily determined. An “embedding space” (or a “vector space”) refers to a mathematical set having embeddings (or vectors) as components and is characterized by a dimension specifying a number of independent directions in the embedding space.

A “synthetic image” refers to an image generated by an image generation model. A “synthetic background” refers to a background generated by the image generation model. A “background” may refer to a scene that at least partially surrounds an object or is overlapped by an object.

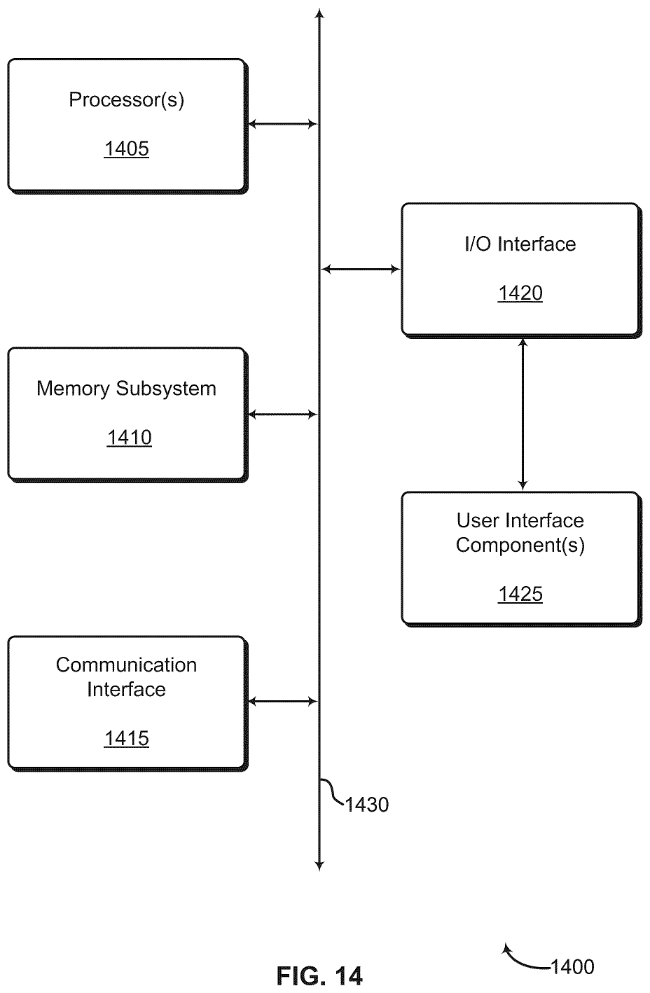

Image generation apparatus 105 is an example of, or includes aspects of, the corresponding element described with reference to FIGS. 3-5, 14, and 15. According to some aspects, image generation apparatus 105 includes a computer-implemented network. In some embodiments, the computer-implemented network includes a machine learning model (such as image generation model 110, described in further detail with reference to FIGS. 3-7 and 15). Image generation apparatus 105 may also include one or more processors, a memory subsystem, a communication interface, an I/O interface, one or more user interface components, and a bus as described with reference to FIG. 14. Additionally, image generation apparatus 105 may communicate with user device 130 and database 125 via cloud 120.

According to some aspects, image generation apparatus 105 is implemented on a server. A server provides one or more functions to users linked by way of one or more of various networks, such as cloud 120. The server may include a microprocessor board that includes a microprocessor responsible for controlling all aspects of the server. The server uses the microprocessor and protocols such as hypertext transfer protocol (HTTP), simple mail transfer protocol (SMTP), file transfer protocol (FTP), and simple network management protocol (SNMP) to exchange data with other devices or users on one or more of the networks. The server may be configured to send and receive hypertext markup language (HTML) formatted files (e.g., for displaying web pages). In various embodiments, the server comprises a general-purpose computing device, a personal computer, a laptop computer, a mainframe computer, a supercomputer, or any other suitable processing apparatus.

Image generation model 110 is an example of, or includes aspects of, the corresponding element described with reference to FIGS. 3-7 and 15. According to some aspects, image generation model 110 comprises image generation parameters (e.g., machine learning parameters) stored in a memory unit of image generation apparatus 105 (e.g., the memory unit 1510 described with reference to FIG. 15). According to some aspects, image generation model comprises an artificial neural network (ANN) trained to generate a synthetic image.

Further detail regarding the architecture of an image generation system is provided with reference to FIGS. 3-7 and 14-15. Further detail regarding an image generation process is provided with reference to FIGS. 2 and 8-10. Further detail regarding a process for training a machine learning model is provided with reference to FIGS. 11-13.

Cloud 120 is a computer network configured to provide on-demand availability of computer system resources, such as data storage and computing power. Cloud 120 may provide resources without active management by a user. The term “cloud” is sometimes used to describe data centers available to many users over the Internet. Some large cloud networks have functions distributed over multiple locations from central servers. A server is designated an edge server if the server has a direct or close connection to a user. Cloud 120 may be limited to a single organization or be available to many organizations. In one example, cloud 120 includes a multi-layer communications network comprising multiple edge routers and core routers. In another example, cloud 120 is based on a local collection of switches in a single physical location. According to some aspects, cloud 120 provides communications between image generation apparatus 105, database 125, and user device 130.

Database 125 is an organized collection of data. In an example, database 125 stores data in a specified format known as a schema. According to some aspects, database 125 is structured as a single database, a distributed database, multiple distributed databases, or an emergency backup database. A database controller may manage data storage and processing in database 125. A user may interact with the database controller, or the database controller may operate automatically without interaction from the user. According to some aspects, database 125 is included in image generation apparatus 105. According to some aspects, database 125 is external to image generation apparatus 105 and communicates with image generation apparatus 105 via cloud 120.

According to some aspects, user device 130 is a personal computer, laptop computer, mainframe computer, palmtop computer, personal assistant, mobile device, or any other suitable processing apparatus. User device 130 may include software that displays user interface 115 (e.g., a graphical user interface) provided by image generation apparatus 105. The user interface 115 allows information (such as images, prompts, etc.) to be communicated between user 135 and image generation apparatus 105.

According to some aspects, a user device user interface enables user 135 to interact with user device 130. In some embodiments, the user device user interface may include an audio device, such as an external speaker system, an external display device such as a display screen, or an input device (e.g., a remote-control device interfaced with the user interface directly or through an I/O controller module). In some cases, the user device user interface may be a graphical user interface.

Input image 140 is an example of, or includes aspects of, the corresponding element described with reference to FIGS. 3-5. Input prompt 145 is an example of, or includes aspects of, the corresponding element described with reference to FIGS. 3-5. Synthetic image 150 is an example of, or includes aspects of, the corresponding element described with reference to FIGS. 3-5.

FIG. 2 shows an example of a method 200 for image relighting according to aspects of the present disclosure. According to some aspects, an image generation system performs method 200 to generate a synthetic image depicting an object that is relighted according to a lighting condition described by an input prompt.

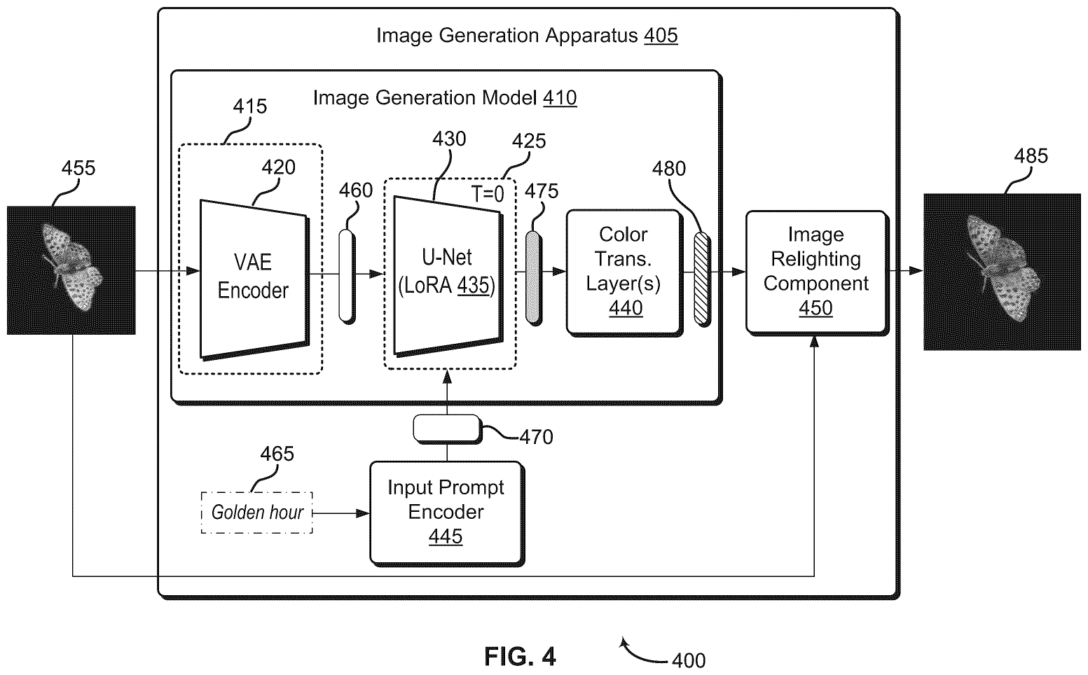

A LoRA layer (e.g., the LoRA layer described with reference to FIGS. 3 and 4) adapts weights of a base model to perform a task in a parameter-efficient manner such that the base model does not need to be trained to perform the task. In some embodiments, the LoRA layer borrows weights of a pre-trained image generation model (e.g., the image generation model described with reference to FIGS. 1, 3-7, and 15, e.g., a U-Net), and uses the borrowed weights to generate relighted image features in a latent space based on an input image in a pixel space and the input prompt. Once the LoRA layer is trained (for example, as described with reference to FIGS. 11-13), the image generation model including the trained LoRA layer uses one timestep (e.g., T=0) to predict the relighted image features. The image generation model can then generate a synthetic image depicting the relighted object based on the relighted image features by decoding the relighted image features from the latent space to the pixel space.

Additionally, in some embodiments, the image generation model generates the relighted image features using a LoRA layer included in an encoder portion of the image generation model, and uses a color transformation function to predict color transformation parameters based on the relighted image features. The image generation model can then generate the synthetic image depicting the relighted object by applying the predicted color transformation parameters to the input image.

Furthermore, in some embodiments, the image generation model uses an image generation process performed by other layers of the image generation model, such as a diffusion process, to generate a background of the synthetic image based on the input prompt, either in parallel with generating the relighted object or after generating the relighted object. In some embodiments, the other layers include one or more additional LoRA layers that adapt weights of the image generation model to generate the background of the synthetic image using the diffusion process. Therefore, the image generation system obtains a synthetic image in which a relighted object is accurately composited with a background, where the relighted object and the background are both generated according to a same lighting condition. Accordingly, in some embodiments, one or more LoRA layers allows the image generation model to function as both a relighting module and as a diffusion outpainter.

At operation 205, a user provides an input image depicting an object and a prompt describing a lighting condition. In some cases, the operations of this step refer to, or may be performed by, a user as described with reference to FIG. 1. For example, the user provides the input image and the prompt to an image generation apparatus (such as the image generation apparatus 105 described with reference to FIG. 1) via a user interface (such as the user interface 115 described with reference to FIG. 1) provided by the image generation apparatus on a user device (such as the user device described with reference to FIG. 1). The prompt may be a text prompt (e.g., “Golden hour”), an image prompt, or a prompt in another modality (such as audio).

At operation 210, the system generates a synthetic image depicting the object with the lighting condition. In some cases, the operations of this step refer to, or may be performed by, an image generation apparatus as described with reference to FIGS. 1, 3-5, 14, and 15. In an example, the image generation apparatus generates the synthetic image as described with reference to FIG. 3, 4, or 5.

At operation 215, the system provides the synthetic image to a user. In some cases, the operations of this step refer to, or may be performed by, an image generation apparatus as described with reference to FIGS. 1, 3-5, 14, and 15. In an example, the image generation apparatus provides the synthetic image to the user via the user interface.

FIG. 3 shows an example of an image generation system 300 for generating a synthetic image 380 according to aspects of the present disclosure. The example shown includes image generation system 300, input image 355, input image features 360, input prompt 365, input prompt embedding 370, relighted image features 375, and synthetic image 380. In one aspect, image generation system 300 includes image generation apparatus 305. In one aspect, image generation apparatus 305 includes image generation model 310 and input prompt encoder 350. In one aspect, image generation model 310 includes variational autoencoder (VAE) 315 and U-Net 330. In one aspect, VAE 315 includes VAE encoder 320 and VAE decoder 325. In one aspect, U-Net 330 includes U-Net encoder 335, U-Net decoder 340, and LoRA layer 345.

Referring to FIG. 3, image generation system 300 generates a synthetic image (e.g., synthetic image 380) in a pixel space based on relighted image features (e.g., relighted image features 375) generated based on an input image depicting an object (e.g., input image 355 depicting a butterfly) and an input prompt describing a lighting condition, either explicitly or implicitly (e.g., input prompt 365, describing a lighting condition “Golden hour”).

For example, VAE encoder 320 of VAE 315 generates image features (e.g., input image features 360) based on the input image. The image features are an embedding of the input image in a latent space (e.g., an embedding space). Input prompt encoder 350 (e.g., a text encoder, an image encoder, an encoder for another modality, or a multimodal encoder) generates an input prompt embedding (e.g., input prompt embedding 370) based on the input prompt.

U-Net 330 includes LoRA layer 345 with weights borrowed from U-Net encoder 335 and U-Net decoder 340. LoRA layer 345 generates the relighted image features 375 based on the image features and the input prompt embedding. The T=0 of FIG. 3 indicates that LoRA layer 345 predicts or generates the relighted image features in one timestep. VAE decoder 325 decodes the relighted image features from the latent space to the pixel space to obtain the synthetic image.

In some embodiments, the input image depicts the object independently of other image elements. In some embodiments, image generation apparatus 305 generates the input image by extracting the object from another image (for example, using object detection).

Image generation system 300 is an example of, or includes aspects of, the corresponding element described with reference to FIGS. 1, 4, and 5. Image generation apparatus 305 is an example of, or includes aspects of, the corresponding element described with reference to FIGS. 1, 4, 5, 14, and 15. Image generation model 310 is an example of, or includes aspects of, the corresponding element described with reference to FIGS. 1, 4-7, and 15.

VAE 315 and VAE encoder 320 are examples of, or include aspects of, the corresponding elements described with reference to FIG. 4. According to some aspects, VAE 315 comprises autoencoder parameters (e.g., machine learning parameters) stored in a memory unit of image generation apparatus 305 (such as the memory unit 1510 described with reference to FIG. 15).

A variational autoencoder (VAE) comprises an ANN trained to encode input data into a lower-dimensional latent space and then decode the encoded input data back into the original input space. In some cases, a VAE differs from other autoencoder implementations by imposing a probabilistic structure on the latent space.

According to some aspects, a VAE is able to generate new data samples by sampling from a learned latent space distribution, thereby generating new data points that resemble training data. VAEs are widely used in various applications, including image generation, data compression, and representation learning, due to an ability to learn rich probabilistic representations of high-dimensional data. VAEs provide a principled framework for generative modeling and are successful in generating realistic-looking samples across different domains.

VAE encoder 320 receives input data and outputs a mean vector and a variance vector representing parameters of a probability distribution (such as Gaussian) of the input data in the latent space. In some cases, VAE encoder 320 samples a latent vector from the mean vector and the variance vector using a reparameterization trick, where the latent vector is obtained by sampling from a standard normal distribution and then scaling and shifting the samples according to the mean vector and the variance vector. According to some aspects, VAE decoder 325 reconstructs the original input data based on the latent vector.

According to some aspects, VAE 315 is trained by optimizing a loss function that includes a reconstruction loss and a regularization term. In some cases, the reconstruction loss encourages the decoder network to generate an output similar to an original input, while the regularization term, such as a Kullback-Leibler (KL) divergence between the learned distribution and the prior distribution, encourages the latent space to follow a specific distribution, for example, a standard normal distribution. In some cases, the regularization term helps to ensure that the latent space is well-structured and continuous.

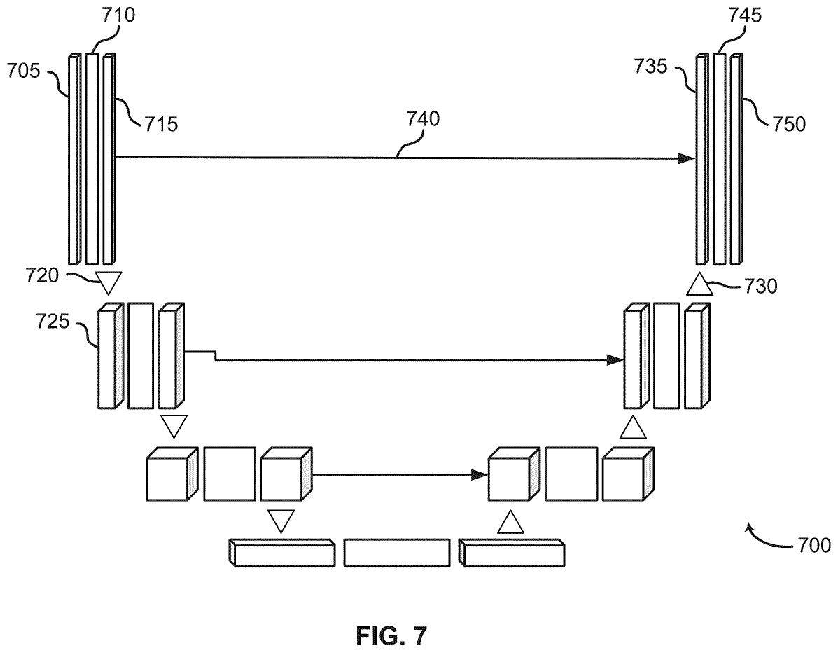

U-Net 330 is an example of, or includes aspects of, the corresponding element described with reference to FIGS. 4 and 7. U-Net encoder 335 is an example of, or includes aspects of, the corresponding element described with reference to FIG. 4.

According to some aspects, a U-Net is a type of ANN characterized by a U-shaped structure including a contracting path (e.g., an encoder) followed by an expanding path (e.g., a decoder). The contracting path includes a series of convolutional and pooling layers that progressively reduce spatial dimensions of an input image while increasing a number of feature channels. Each convolutional block may be followed by a rectified linear unit (ReLU) activation function that introduces non-linearity into the U-Net.

The expanding path includes a series of upsampling and concatenation operations that gradually increase the spatial dimensions of the feature maps while decreasing the number of feature channels. Each upsampling operation may be followed by a convolutional block with ReLU activation. The output of each block in the expanding path is concatenated with the corresponding feature map from the contracting path, allowing the U-Net to retain detailed spatial information from earlier layers.

A U-Net architecture may include skip connections that connect corresponding layers between the contracting and expanding paths, enabling the U-Net to bypass a loss of spatial information during downsampling and facilitate a precise localization of objects in the segmentation output. A final layer of the U-Net may include a convolutional layer followed by a softmax or sigmoid activation function, depending on a number of classes in the segmentation task.

LoRA layer 345 is an example of, or includes aspects of, the corresponding element described with reference to FIG. 4. According to some aspects, a low-rank adaptation (LoRA) layer is an ANN component that is designed to adapt weights of a pre-trained model (e.g., U-Net 330) to a new task or domain with reduced computational complexity and memory requirements. In transfer learning, a model trained on a source domain is fine-tuned on a target domain (e.g., a specific dataset related to a particular task) to leverage knowledge learned from the source domain. However, transferring the entire set of parameters from the pre-trained model may not be optimal due to differences in data distributions between the source and target domains, leading to suboptimal performance or overfitting.

A low-rank adaptation layer addresses this issue by decomposing the weight matrix of a neural network layer into low-rank matrices. The decomposition reduces the number of parameters in the low-rank adaptation layer, making the low-rank adaptation layer more adaptable to the target domain while preserving important features learned from the source domain. By reducing the rank of the weight matrix, the low-rank adaptation layer can capture the underlying structure of the data more efficiently.

Methods for low-rank adaptation include Singular Value Decomposition (SVD) and truncated SVD, which factorize the weight matrix into two or more low-rank matrices. These low-rank matrices are then used to initialize the weights of the adapted model.

By reducing the number of parameters in a model including the low-rank adaptation, the low-rank adaptation layer can speed up training and inference, thereby aiding task completion in resource-constrained environments. By adapting the model's parameters to the target domain while preserving important features from the source domain, low-rank adaptation can lead to more efficient generalization performance on the target task. Low-rank adaptation may act as a form of regularization, mitigating overfitting by imposing constraints on a parameter space of the model.

According to some aspects, a LoRA layer is added to one or more layers of U-Net 330. According to some aspects, a LoRA layer is not added to one or more cross-attention layers of U-Net 330.

Accordingly, low-rank adaptation is technique for parameter-efficient finetuning to generate an image having a photorealistic quality with high diversity. In some embodiments, LoRA layer 345 does not modify other layers included in image generation model 310. In some embodiments, LoRA layer 345 helps to retain a text adherence and content understanding of image generation model 310.

According to some aspects, U-Net 330 comprises a first and a second LoRA module, each comprising one or more LoRA layers (e.g., LoRA layer 345). In some embodiments, the first LoRA module is initialized using weights of U-Net 330 and is trained to predict relighted image features using a single timestep (e.g., T=0) without performing diffusion denoising. In some embodiments, at inference time, weights of the first LoRA module are combined into U-Net 330, and U-Net 330 predicts relighted image features using the weights of the first LoRA module and the single timestep (e.g., without performing diffusion denoising).

In some embodiments, the second LoRA module is initialized using weights of U-Net 330 and is trained to perform a diffusion outpainting process (e.g., a diffusion process for generating a background of an image). In some embodiments, at inference time, weights of the second LoRA module are combined into U-Net 330 independently of the weights of the first LoRA module, and U-Net 330 generates a background of an image using the weights of the second LoRA module and a diffusion process.

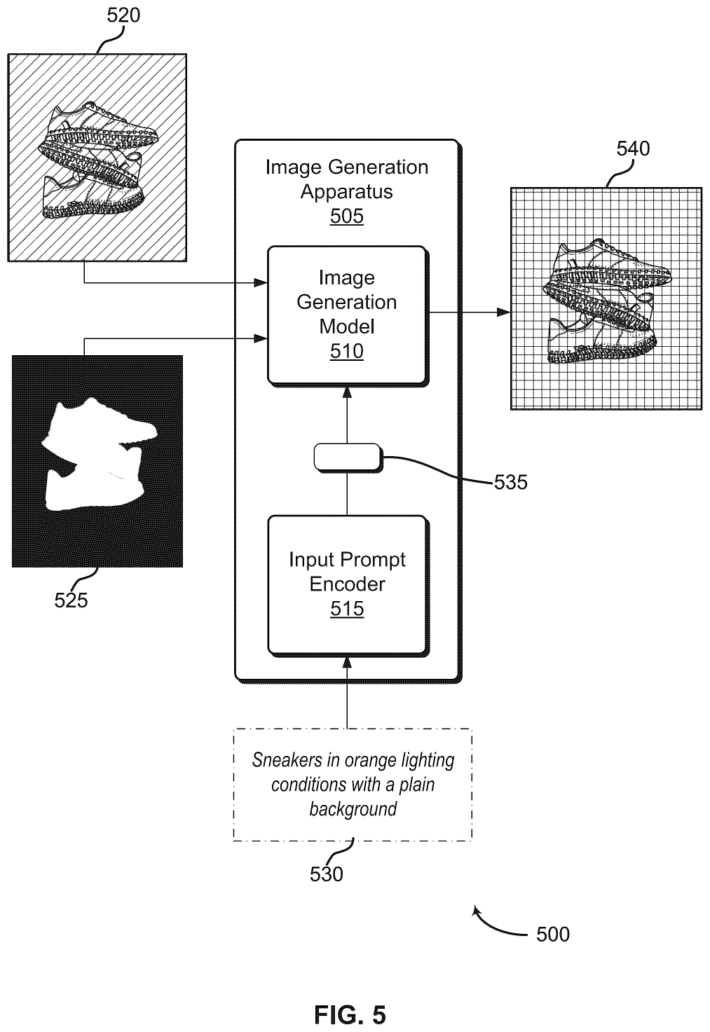

Input prompt encoder 350 is an example of, or includes aspects of, the corresponding element described with reference to FIGS. 4 and 5. According to some aspects, input prompt encoder 350 comprises encoding parameters (e.g., machine learning parameters) stored in the memory unit of image generation apparatus 305.

According to some aspects, input prompt encoder 350 comprises an ANN configured to generate a text embedding based on a text input, such as a recurrent neural network (RNN) or a transformer. According to some aspects, input prompt encoder 350 comprises an ANN configured to generate an image embedding based on an image embedding, such as a CNN or a vision transformer (ViT). According to some aspects, input prompt encoder 350 comprises an ANN configured to generate a multimodal embedding a text input or an image input in a multimodal embedding space.

Input image 355, input prompt 365, and synthetic image 380 are examples of, or include aspects of, the corresponding elements described with reference to FIGS. 1, 4, and 5. Input image features 360 and relighted image features 375 are examples of, or include aspects of, the corresponding elements described with reference to FIG. 4. Input prompt embedding 370 is an example of, or includes aspects of, the corresponding element described with reference to FIGS. 4 and 5.

FIG. 4 shows an example of an image generation system 400 for generating a synthetic image 485 using a color transformation function according to aspects of the present disclosure. The example shown includes image generation system 400, input image 455, input image features 460, input prompt 465, input prompt embedding 470, relighted image features 475, color parameters 480, and synthetic image 485.

In one aspect, image generation system 400 includes image generation apparatus 405. In one aspect, image generation apparatus 405 includes image generation model 410, input prompt encoder 445, and image relighting component 450. In one aspect, image generation model 410 includes variational autoencoder (VAE) 415, U-Net 425, and color transformation layer(s). In one aspect, VAE 415 includes VAE encoder 420. In one aspect, U-Net 425 includes U-Net encoder 430 and LoRA layer 435.

Referring to FIG. 4, according to some aspects, image generation system 400 generates a synthetic image (e.g., synthetic image 485) by applying color parameters (e.g., color parameters 480) to an input image (e.g., input image 455).

For example, VAE encoder 420 of VAE 415 generates image features (e.g., input image features 460) based on the input image. Input prompt encoder 445 generates an input prompt embedding (e.g., input prompt embedding 470) based on the input prompt.

U-Net 425 includes LoRA layer 435 with weights borrowed from U-Net encoder 430. LoRA layer 435 generates relighted image features (e.g., relighted image features 475) based on the image features and the input prompt embedding. The T=0 of FIG. 4 indicates that LoRA layer 435 generates the relighted image features in one timestep.

One or more color transformation layers 440 (e.g., a parametric head) predict color parameters 480 using a color transformation function. For example, in some cases, the input image is an RGB image including three color channels, e.g., a red, green, and blue channel, where each color channel is associated with a same number of color parameters (e.g., 32, for 96 total color parameters associated with the input image). Color transformation layers 440 predict the color parameters 480 according to the color transformation function based on the relighted image features. For example, the color transformation function may be considered as a lookup table, such that the one or more color transformation layers 440 map color information (e.g., color intensity, brightness, etc.) for color information provided by the relighted image features to the input image to obtain the synthetic image.

In some embodiments, image relighting component 450 applies the color transformation to each pixel of the input image using parametric harmonization. In an example, the color parameters are three piecewise linear curves with 32 control points, and image relighting component 450 applies the three linear curves to each color channel of the input image independently. Application of the three linear curves is a per-pixel operation that can be efficiently computed at any resolution. In some embodiments, image relighting component 450 performs histogram smoothening on the synthetic image to remove artifacts from the synthetic image.

In some embodiments, the color transformation function operates independently of a resolution of the input image, allowing the color transformation function to scale to any output resolution, such that a resolution of the synthetic image is independent of a resolution of the input image. In some embodiments, a user selects a resolution of the synthetic image using the user interface.

Accordingly, comparing FIG. 3 to FIG. 4, U-Net 425 omits a U-Net decoder, and VAE 415 omits a VAE encoder. Instead of decoding relighted image features to obtain the synthetic image, image generation apparatus 405 predicts color parameters based on the relighted image features and applies the predicted color parameters to the input image to obtain the synthetic image.

Image generation system 400 is an example of, or includes aspects of, the corresponding element described with reference to FIGS. 1, 3, and 5. Image generation apparatus 405 is an example of, or includes aspects of, the corresponding element described with reference to FIGS. 1, 3, 5, 14, and 15. Image generation model 410 is an example of, or includes aspects of, the corresponding element described with reference to FIGS. 1, 3, 5-7, and 15.

VAE 415, VAE encoder 420, U-Net encoder 430, and LoRA layer 435 are examples of, or include aspects of, the corresponding elements described with reference to FIG. 3. U-Net 425 is an example of, or include aspects of, the corresponding element described with reference to FIGS. 3 and 7.

Color transformation layer(s) 440 comprises color transformation parameters (e.g., machine learning parameters) stored in a memory unit of image generation apparatus 405 (such as the memory unit 1510 described with reference to FIG. 15). According to some aspects, color transformation layers 440 comprise a feedforward network. A feedforward network is an ANN in which connections between nodes of the ANN do not form cycles, such that information moves in one direction, from the input nodes of the ANN, through the hidden layers (if any), and finally to the output nodes of the ANN without any feedback loops. According to some aspects, color transformation layers 440 include one or more convolutional layers. According to some aspects, color transformation layers 440 include one or more linear layers.

According to some aspects, U-Net 425 and color transformation layer(s) 440 comprise a parametric U-Net that borrows layers from U-Net 425. According to some aspects, output blocks of U-Net 425 are omitted. Input prompt encoder 445 is an example of, or includes aspects of, the corresponding element described with reference to FIGS. 3 and 5.

Input image 455, input prompt 465, and synthetic image 485 are examples of, or include aspects of, the corresponding elements described with reference to FIGS. 1, 3, and 5. Input image features 460 and relighted image features 475 are examples of, or include aspects of, the corresponding elements described with reference to FIG. 3. Input prompt embedding 470 is an example of, or includes aspects of, the corresponding element described with reference to FIGS. 3 and 5.

Accordingly, a method, system, and non-transitory computer readable medium storing code for image processing include obtaining an input image and an input prompt that describes a lighting condition; generating, an image generation model, relighted image features based on the input image and the input prompt; computing a color transformation function based on the relighted image features; and generating, using the image generation model, a synthetic image based on the input image and the color transformation, wherein the synthetic image depicts the input image with the lighting condition.

FIG. 5 shows an example of an image generation system 500 for generating a synthetic image background according to aspects of the present disclosure. The example shown includes image generation system 500, input image 520, editing mask 525, input prompt 530, input prompt embedding 535, and synthetic image 540. In one aspect, image generation system 500 includes image generation apparatus 505. In one aspect, image generation apparatus 505 includes image generation model 510 and input prompt encoder 515.

Referring to FIG. 5, image generation model 510 generates a synthetic image (e.g., synthetic image 540) including a relighted object and a background based on an input image (e.g., input image 520). The relighted object for the synthetic image is generated as described with reference to FIG. 3 or FIG. 4.

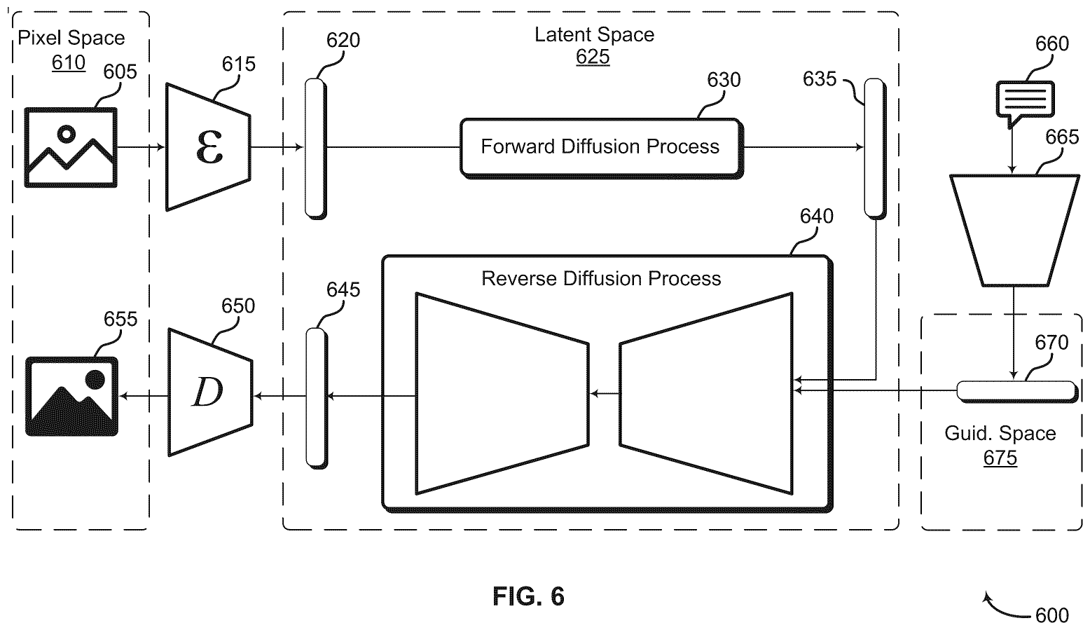

Image generation model 510 receives the input image, an editing mask (e.g., editing mask 525), and an input prompt embedding (e.g., input prompt embedding 535) generated by input prompt encoder 515 based on an input prompt (e.g., input prompt 530) as input and generates the synthetic image 540 using an image generation process, such as the reverse diffusion process described with reference to FIGS. 6 and 9-10. The input prompt describes content of the background.

The editing mask restrains the image generation process from generating new content in areas corresponding to a masked-out region, and therefore an object of the input image that corresponds to the masked-out region is not affected by the image generation process. Accordingly, the relighted object obtained as described with reference to FIG. 3 or 4 is composited with a synthetic background generated by the image generation process in the synthetic image. In some embodiments, image generation apparatus generates the editing mask based on the input image. In an example, the image generation apparatus generates the mask using an object detection or bounding box algorithm, or an ANN, such as a Mask-R-CNN.

In some embodiments, the input prompt used for generating the relighted object is also used for the image generation process. The input prompt may imply a lighting condition (e.g., “a leafy green forest”) or may directly describe the lighting condition (e.g., “sneakers in orange lighting conditions with a plain background”). Because the same input prompt is used to generate the relighted object and the background of the synthetic image, the relighted object and the background share a lighting condition.

Image generation system 500 is an example of, or includes aspects of, the corresponding element described with reference to FIGS. 1, 3, and 4. Image generation apparatus 505 is an example of, or includes aspects of, the corresponding element described with reference to FIGS. 1, 3, 4, 14, and 15. Image generation model 510 is an example of, or includes aspects of, the corresponding element described with reference to FIGS. 1, 3-4, 6-7, and 15. Input prompt encoder 515 is an example of, or includes aspects of, the corresponding element described with reference to FIGS. 3 and 4.

Input image 520, input prompt 530, and synthetic image 540 are examples of, or include aspects of, the corresponding elements described with reference to FIGS. 1, 3, and 4. Input prompt embedding 535 is an example of, or includes aspects of, the corresponding element described with reference to FIGS. 3 and 4.

FIG. 6 shows an example of a guided diffusion model 600 according to aspects of the present disclosure. In some examples, guided diffusion model 600 describes the operation and architecture of the image generation model 1515 described with reference to FIG. 15.

Diffusion models are a class of generative neural networks which can be trained to generate new data with features similar to features found in training data. In particular, diffusion models can be used to generate novel images. Diffusion models can be used for various image generation tasks including image super-resolution, generation of images with perceptual metrics, conditional generation (e.g., generation based on text guidance), image inpainting, and image manipulation.

Diffusion models work by iteratively adding noise to the data during a forward process and then learning to recover the data by denoising the data during a reverse process. For example, during training, guided diffusion model 600 may take an original image 605 in a pixel space 610 as input and apply and image encoder 615 to convert original image 605 into original image features 620 in a latent space 625. Then, a forward diffusion process 630 gradually adds noise to the original image features 620 to obtain noisy features 635 (also in latent space 625) at various noise levels.

Next, a reverse diffusion process 640 (e.g., a U-Net ANN, such as the U-Net described with reference to FIG. 7) gradually removes the noise from the noisy features 635 at the various noise levels to obtain denoised image features 645 in latent space 625. In some examples, the denoised image features 645 are compared to the original image features 620 at each of the various noise levels, and parameters of the reverse diffusion process 640 of the diffusion model are updated based on the comparison. Finally, an image decoder 650 decodes the denoised image features 645 to obtain an output image 655 in pixel space 610. In some cases, an output image 655 is created at each of the various noise levels. The output image 655 can be compared to the original image 605 to train the reverse diffusion process 640.

In some cases, image encoder 615 and image decoder 650 are pre-trained prior to training the reverse diffusion process 640. In some examples, they are trained jointly, or the image encoder 615 and image decoder 650 are fine-tuned jointly with the reverse diffusion process 640.

The reverse diffusion process 640 can also be guided based on a text prompt 660, or another guidance prompt, such as an image, a layout, a segmentation map, a mask, etc. The text prompt 660 can be encoded using an encoder 665 (e.g., a multimodal encoder) to obtain guidance features 670 in guidance space 675. The guidance features 670 can be combined with the noisy features 635 at one or more layers of the reverse diffusion process 640 to ensure that the output image 655 includes content described by the text prompt 660 or other guidance prompt. For example, guidance features 670 can be combined with the noisy features 635 using a cross-attention block within the reverse diffusion process 640.

Cross-attention, also known as multi-head attention, is an extension of the attention mechanism. In some cases, cross-attention enables reverse diffusion process 640 to attend to multiple parts of an input sequence simultaneously, capturing interactions and dependencies between different elements. In cross-attention, there are typically two input sequences: a query sequence and a key-value sequence. The query sequence represents the elements to receive attention, while the key-value sequence contains the elements to attend to. In some cases, to compute cross-attention, the cross-attention block transforms (for example, using linear projection) each element in the query sequence into a “query” representation, while the elements in the key-value sequence are transformed into “key” and “value” representations.

The cross-attention block calculates attention scores by measuring a similarity between each query representation and the key representations, where a higher similarity indicates that more attention is given to a key element. An attention score indicates an importance or relevance of each key element to a corresponding query element.

The cross-attention block then normalizes the attention scores to obtain attention weights (for example, using a softmax function), where the attention weights determine how much information from each value element is incorporated into the final attended representation. By attending to different parts of the key-value sequence simultaneously, the cross-attention block captures relationships and dependencies across the input sequences, allowing reverse diffusion process 1040 to better understand the context and generate more accurate and contextually relevant outputs.

Methods of operating diffusion models include a Denoising Diffusion Probabilistic Model (DDPM) and a Denoising Diffusion Implicit Models (DDIM). In DDPM, the generative process includes reversing a stochastic Markov diffusion process. DDIMs, on the other hand, use a deterministic process so that the same input results in the same output. In some cases, DDIM can reduce the number of timesteps during image generation. Diffusion models may also be characterized by whether the noise is added to the image itself, or to image features generated by an encoder (i.e., latent diffusion). In a pixel diffusion model, noise is added and removed in pixel space. In a latent diffusion model, the noise is added (and removed) in a latent space of image features rather than in pixel space. Thus, a latent diffusion model generates image features using reverse diffusion, and these image features can be decoded to obtain a synthetic image. In some embodiments, guided diffusion model 600 is implemented as a guided pixel diffusion model.

FIG. 7 shows an example of a U-Net 700 according to aspects of the present disclosure. In some examples, U-Net 700 is an example of the component that performs the reverse diffusion process 640 of guided diffusion model 600 described with reference to FIG. 6, and includes architectural elements of the image generation model 1515 described with reference to FIG. 15. The U-Net 700 depicted in FIG. 7 is an example of, or includes aspects of, the architecture used within the reverse diffusion process described with reference to FIG. 6. U-Net 700 is an example of, or includes aspects of, the corresponding element described with reference to FIGS. 3 and 4.

In some examples, diffusion models are based on a neural network architecture known as a U-Net. The U-Net 700 takes input features 705 having an initial resolution and an initial number of channels and processes the input features 705 using an initial neural network layer 710 (e.g., a convolutional network layer) to produce intermediate features 715. The intermediate features 715 are then down-sampled using a down-sampling layer 720 such that down-sampled features 725 features have a resolution less than the initial resolution and a number of channels greater than the initial number of channels.

This process is repeated multiple times, and then the process is reversed. That is, the down-sampled features 725 are up-sampled using up-sampling process 730 to obtain up-sampled features 735. The up-sampled features 735 can be combined with intermediate features 715 having a same resolution and number of channels via a skip connection 740. These inputs are processed using a final neural network layer 745 to produce output features 750. In some cases, the output features 750 have the same resolution as the initial resolution and the same number of channels as the initial number of channels.

In some cases, U-Net 700 takes additional input features to produce conditionally generated output. For example, the additional input features could include a vector representation of an input prompt. The additional input features can be combined with the intermediate features 715 within the neural network at one or more layers. For example, a cross-attention module can be used to combine the additional input features and the intermediate features 715.

### Image Generation

FIG. 8 shows an example of a method 800 for generating a synthetic image according to aspects of the present disclosure. Referring to FIG. 8, an image generation system (such as the image generation system described with reference to FIGS. 1 and 3-5) performs method 800 to generate a synthetic image based on an input image and relighted image features, such that an object included in the input image is included in the synthetic image and relighted (for example, including one or more of a different coloring, reflective property, shadowing, brightness, etc.) according to a lighting condition included in an input prompt (such as a text prompt or an image prompt).

In some cases, the synthetic image includes a background at least partially surrounding the object, where content of the background is described by an input prompt (such as a text prompt or an image prompt). Accordingly, in some cases, aspects of the present disclosure provide a unified model for diffusion based outpainting, relighting using a single base model with task specific layers, end-to-end text conditioning for more diverse background generation and composition, and image- or text-guided harmonization and outpainting. In some cases, aspects of the present disclosure provide low-rank-adaptation-based scalable parametric harmonization effects.

At operation 805, the system obtains an input image and an input prompt, where the input image depicts an object and the input prompt describes a lighting condition for the object. In some cases, the operations of this step refer to, or may be performed by, an image generation apparatus as described with reference to FIGS. 1, 3-5, 14, and 15. In an example, a user provides the input image and the input prompt to a user interface provided by the image generation apparatus on a user device. In some cases, the input prompt is a text prompt including a text string.

In some cases, the input image depicts only the object and omits other content. In some cases, the input prompt is an image prompt including an image. In some cases, the input prompt directly describes the lighting condition (e.g., “A sunlit object”). In some cases, the input prompt indirectly implies the lighting condition (e.g., “A leafy green forest”). In some embodiments, the lighting condition includes at least one of a color, a brightness, a shadow, and a reflective property.

At operation 810, the system generates, using a low-rank adaptation layer of an image generation model, relighted image features based on the input image and the input prompt, where the relighted image features represent the object with the lighting condition. In some cases, the operations of this step refer to, or may be performed by, an image generation model as described with reference to FIGS. 1, 3-7, and 15. In an example, the image generation model generates the relighted image features as described with reference to FIG. 3 or 4.

According to some aspects, generating the relighted image features includes encoding the input prompt to obtain a prompt embedding, where the relighted image features are based on the prompt embedding. In some embodiments, the input prompt includes a text prompt. In some embodiments, the input prompt includes an image prompt. In some embodiments, generating the relighted image features includes encoding the input image to obtain an image embedding, where the relighted image features are based on the image embedding.

At operation 815, the system generates, using the image generation model, a synthetic image based on the relighted image features, where the synthetic image depicts the object with the lighting condition. In some cases, the operations of this step refer to, or may be performed by, an image generation model as described with reference to FIGS. 1, 3-7, and 15. In an example, the image generation model generates the synthetic image as described with reference to FIG. 3, 4, or 5.

In an example, generating the synthetic image includes decoding the relighted image features to obtain the synthetic image. In an example, generating the synthetic image includes computing a color transformation function based on the relighted image features, where the synthetic image is based on the color transformation function. In an example, generating the synthetic image includes generating a background of the synthetic image, where content of the background is described by the input prompt. In an example, the background is generated based on an editing mask. In an example, generating the synthetic image includes obtaining a noise map and denoising the noise map based on the input prompt to obtain the synthetic image.

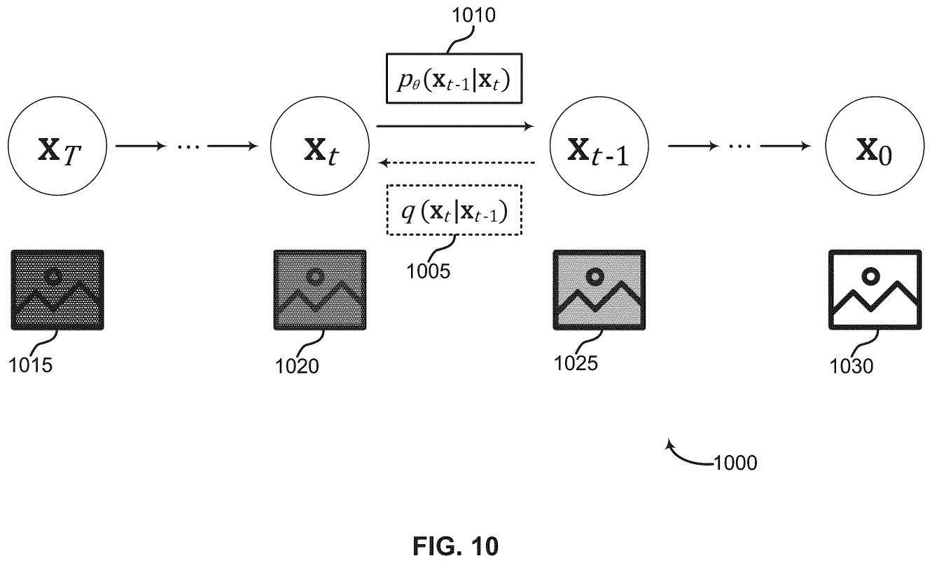

In some cases, the image generation model uses image generation parameters to perform a diffusion process (such as the reverse diffusion process described with reference to FIGS. 6 and 10) to obtain the synthetic image, where the synthetic image includes the object and a background at least partially surrounding the object. In some cases, the generation of the background is guided by a prompt and an editing mask, such that diffusion does not occur in masked region corresponding to the object and occurs in a non-masked region corresponding to the background. In some cases, the user provides the editing mask via the user interface. In some cases, a mask component generates the editing mask based on the input image, such that a masked region corresponds to an outline of the object, and an unmasked region surrounds the masked region.

According to some aspects, the image generation model generates the synthetic image in two phases. In some cases, the image generation model generates the relighted object for the synthetic image in a first phase and generates the background for the synthetic image in a second phase following the first phase. In some embodiments, the first phase includes a use of a first LoRA module to predict relighted image features using a single timestep, and the second phase includes a use of a second LoRA module to generate the background for the synthetic image using a diffusion process. According to some aspects, the image generation model generates the synthetic image in a single image generation phase.

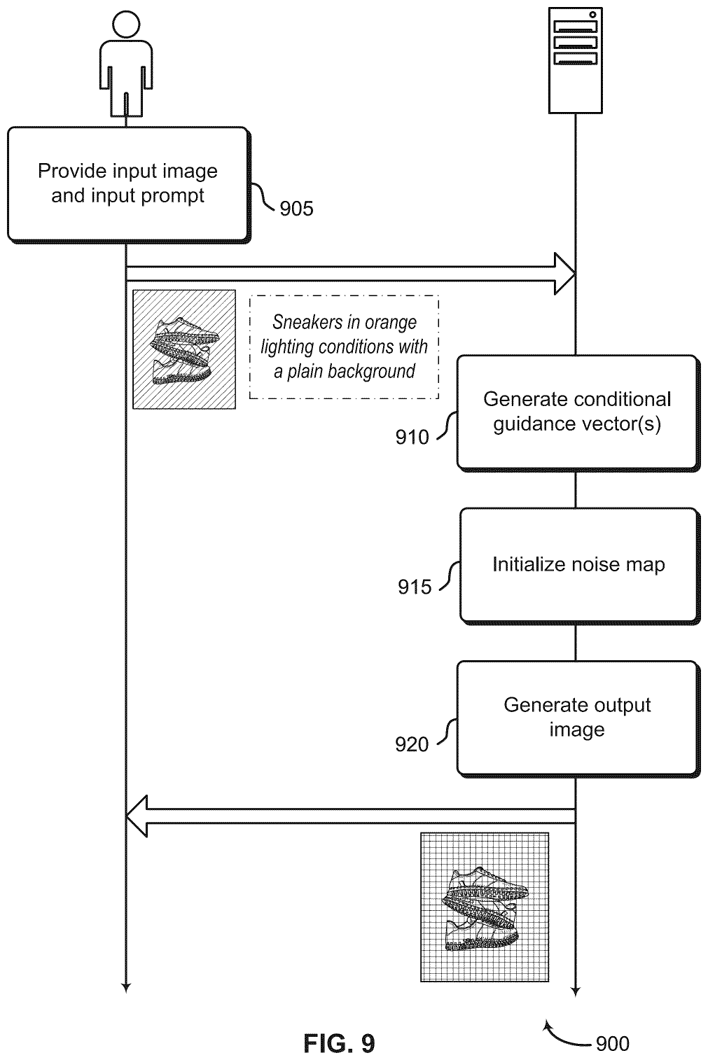

FIG. 9 shows an example of a method 900 for conditional image generation according to aspects of the present disclosure. In some examples, method 900 describes an operation of the image generation model 1515 described with reference to FIG. 15, such as an application of the guided diffusion model 600 described with reference to FIG. 6. In some examples, these operations are performed by a system including a processor executing a set of codes to control functional elements of an apparatus such as the image generation model described in FIG. 6.

Additionally or alternatively, steps of the method 900 may be performed using special-purpose hardware. Generally, these operations are performed according to the methods and processes described in accordance with aspects of the present disclosure. In some cases, the operations described herein are composed of various substeps, or are performed in conjunction with other operations.

At operation 905, a user provides an input image and an input prompt describing content to be included in a generated image. For example, a user may provide the prompt “sneakers in orange lighting conditions with a plain background”. In some examples, guidance can be provided in a form other than text, such as via an image, a sketch, a layout, or an editing mask.

At operation 910, the system converts the text prompt (or other guidance) into a conditional guidance vector or other multi-dimensional representation. For example, text may be converted into a vector or a series of vectors using a transformer model, or a multi-modal encoder. In some cases, the encoder for the conditional guidance is trained independently of the diffusion model.

At operation 915, a noise map is initialized that includes random noise. The noise map may be in a pixel space or a latent space. By initializing an image with random noise, different variations of an image including the content described by the conditional guidance can be generated.

At operation 920, the system generates an image based on the noise map and the conditional guidance vector. For example, the image may be generated using a reverse diffusion process as described with reference to FIG. 10.

FIG. 10 shows an example of a diffusion process 1000 according to aspects of the present disclosure. In some examples, diffusion process 1000 describes an operation of the image generation model 1515 described with reference to FIG. 15.

As described above with reference to FIG. 6, using a diffusion model can involve both a forward diffusion process 1005 for adding noise to an image (or features in a latent space) and a reverse diffusion process 1010 for denoising the images (or features) to obtain a denoised image. The forward diffusion process 1005 can be represented as q(xₜ|xₜ₋₁), and the reverse diffusion process 1010 can be represented as p(xₜ₋₁|xₜ). In some cases, the forward diffusion process 1005 is used during training to generate images with successively greater noise, and a neural network is trained to perform the reverse diffusion process 1010 (i.e., to successively remove the noise).

In an example forward process for a latent diffusion model, the model maps an observed variable x₀ (either in a pixel space or a latent space) intermediate variables x₁, . . . , x_{T} using a Markov chain. The Markov chain gradually adds Gaussian noise to the data to obtain the approximate posterior q(x_{1:T}|x₀) as the latent variables are passed through a neural network such as a U-Net, where x₁, . . . , x_{T} have the same dimensionality as x₀.

The neural network may be trained to perform the reverse process. During the reverse diffusion process 1010, the model begins with noisy data x_{T}, such as a noisy image 1015, and denoises the data to obtain the p(xₜ₋₁| xₜ). At each step t−1, the reverse diffusion process 1010 takes xₜ, such as first intermediate image 1020, and t as input. Here, t represents a step in the sequence of transitions associated with different noise levels, The reverse diffusion process 1010 outputs xₜ₋₁, such as second intermediate image 1025 iteratively until x_{T} reverts back to x₀, the original image 1030. The reverse process can be represented as:

$${p}_{θ} ( {x}_{t - 1} \vert {x}_{t} ) : = N ( {x}_{t - 1} ; {μ}_{θ} ( {x}_{1} , t ) , {\sum }_{θ} ( {x}_{t} , t ) ) . \qquad ( 1 )$$

The joint probability of a sequence of samples in the Markov chain can be written as a product of conditionals and the marginal probability:

$${x}_{T} : {p}_{θ} ( {x}_{0 : T} ) := p ( {x}_{T} ) {\prod }_{t = 1}^{T} {p}_{θ} ( {x}_{t - 1} \vert {x}_{t} ) , \qquad ( 2 )$$

where P(x_{T})=N(x_{T}; 0, I) is the pure noise distribution as the reverse process takes the outcome of the forward process, a sample of pure noise, as input and Πₜ₌₁^{T} Pθ(xₜ₋₁| xₜ) represents a sequence of Gaussian transitions corresponding to a sequence of addition of Gaussian noise to the sample.

At interference time, observed data x₀ in a pixel space can be mapped into a latent space as input and a generated data \tilde{x} is mapped back into the pixel space from the latent space as output. In some examples, x₀ represents an original input image with low image quality, latent variables x₁, . . . , x_{T} represent noisy images, and \tilde{x} represents the generated image with high image quality.

Accordingly, a method for image relighting using machine learning is described. One or more aspects of the method include obtaining an input image and an input prompt, wherein the input image depicts an object and the input prompt describes a lighting condition for the object; generating, using a low-rank adaptation layer of an image generation model, relighted image features based on the input image and the input prompt, wherein the relighted image features represent the object with the lighting condition; and generating, using the image generation model, a synthetic image based on the relighted image features, wherein the synthetic image depicts the object with the lighting condition. In some aspects, the lighting condition includes at least one of a color, a brightness, a shadow, and a reflective property.

In some examples, generating the relighted image features includes encoding the input prompt to obtain a prompt embedding, wherein the relighted image features are based on the prompt embedding. In some aspects, the input prompt comprises a text prompt. In some aspects, the input prompt comprises an image prompt.

In some examples, generating the relighted image features includes encoding the input image to obtain an image embedding, wherein the relighted image features are based on the image embedding. In some examples, generating the relighted image features includes computing a color transformation function, wherein the relighted image features are based on the color transformation function. Some examples further include predicting one or more color parameters based on the color transformation function, wherein the synthetic image is based on the one or more color parameters.

In some examples, generating the synthetic image includes generating a background of the synthetic image, wherein content of the background is described by the input prompt. Some examples of the method further include generating the background of the synthetic image based on an editing mask.

In some examples, generating the synthetic image includes obtaining a noise map. Some examples further include denoising the noise map based on the input prompt to obtain the synthetic image.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Training

FIG. 11 shows an example of a method 1100 for training an image generation model according to aspects of the present disclosure. Referring to FIG. 11, an image generation model (such as the image generation model described with reference to FIGS. 1, 3-7, and 15) is trained to generate a synthetic image based on a training image and a lighting input, where the synthetic image depicts a foreground object with the lighting condition from the lighting input.

According to some aspects, a U-Net implementing a diffusion model (such as the U-Net described with reference to FIGS. 3-4 and 7) is implemented as a backbone for the image generation model, and the U-Net is repurposed for an image-to-image generation training task to train the image generation model to apply a lighting condition including one or more of coloring, brightness, shadowing, and reflective properties to a given foreground object based on an input prompt (such as text prompt or an image prompt).

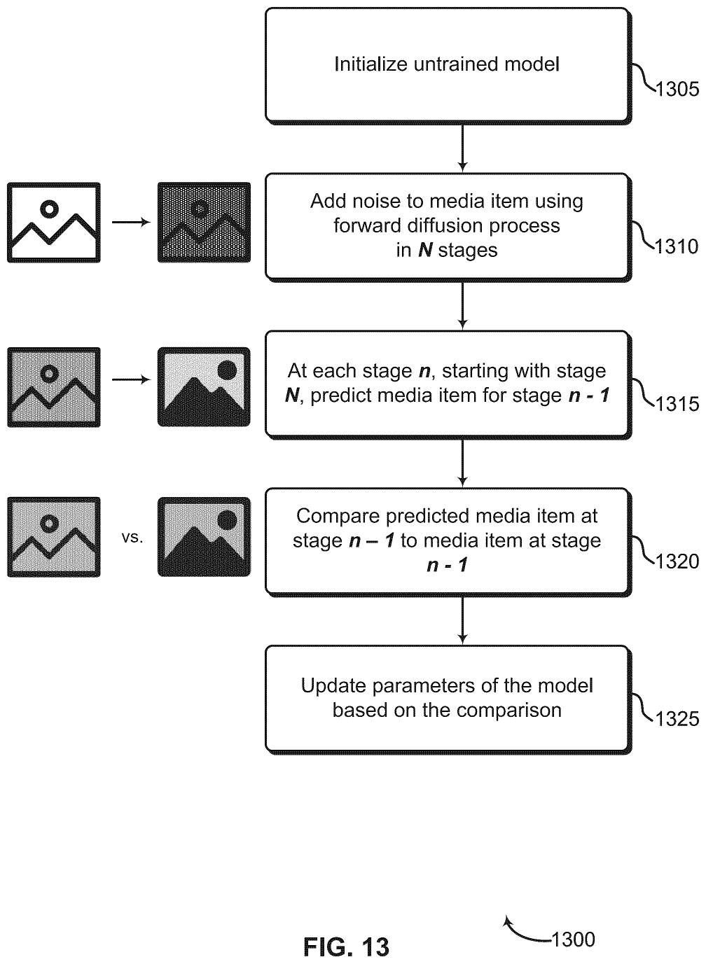

In an example, a low-rank adaptation layer of the image generation model borrows an architecture and pre-trained weights from the U-Net (for example, a diffusion model that is pre-trained as described with reference to FIG. 13). In some embodiments, the low-rank adaptation layer operates with one timestep, unlike iterative denoising process of the diffusion network (e.g., T=0), during training.

At operation 1105, the system obtains a training set including a ground-truth image depicting an object, a lighting input indicating a lighting condition of the object, and a training image depicting the object with a second lighting condition. In some cases, the operations of this step refer to, or may be performed by, a training component as described with reference to FIG. 15.

In some embodiments, the training component retrieves the training set from a database (such as the database described with reference to FIG. 1). In some examples, the training component augments a color of the ground-truth image (e.g., randomly) to obtain the training image. In some embodiments, the lighting input comprises text, an image, or other media item describing the lighting condition.

At operation 1110, the system trains, using the training set, an image generation model to generate a synthetic image based on the training image and the lighting input, where the synthetic image depicts a foreground object with the lighting condition from the lighting input. In some cases, the operations of this step refer to, or may be performed by, a training component as described with reference to FIG. 15.

In an example, the image generation model generates a predicted image based on the training image and the lighting input. In some embodiments, the training component initializes the image generation model based on a pre-trained image generation model (for example, an image generation model pre-trained as described with reference to FIG. 13) and adds a LoRA adaptation layer to the pre-trained image generation model. The image generation model generates relighted image features using the LoRA layer based on the training image and lighting input as described with reference to FIG. 3, and generates the predicted image based on the relighted image features as described with reference to FIG. 3. The training component computes a reconstruction loss function based on the predicted image and the ground-truth image and updates parameters of the LoRA layer based on the reconstruction loss function.

In some embodiments, the image generation model generates relighted image features using the LoRA layer based on the training image and lighting input as described with reference to FIG. 4, and generates the predicted image based on a color transformation function of color transformation layers as described with reference to FIG. 4. The training component computes a reconstruction loss function based on the predicted image and the ground-truth image and updates parameters of one or more of the LoRA layer and the color transformation layers based on the reconstruction loss function.

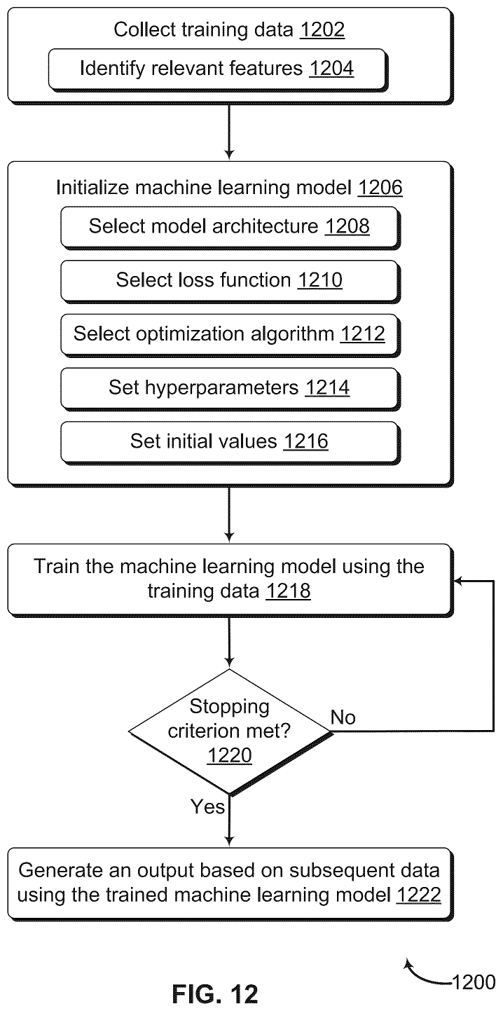

FIG. 12 shows an example of a flow diagram depicting an algorithm as a step-by-step procedure 1200 for training a machine learning model according to aspects of the present disclosure. In some embodiments, the procedure 1200 describes an operation of the training component 1525 described for configuring the image generation model 1515 as described with reference to FIG. 15. The procedure 1200 provides one or more examples of generating training data, use of the training data to train a machine learning model, and use of the trained machine learning model to perform a task.

To begin in this example, a machine learning system collects training data (block 1202) that is to be used as a basis to train a machine learning model, i.e., which defines what is being modeled. The training data is collectable by the machine learning system from a variety of sources. Examples of training data sources include public datasets, service provider system platforms that expose application programming interfaces (e.g., social media platforms), user data collection systems (e.g., digital surveys and online crowdsourcing systems), and so forth. Training data collection may also include data augmentation and synthetic data generation techniques to expand and diversify available training data, balancing techniques to balance a number of positive and negative examples, and so forth.

The machine learning system is also configurable to identify features that are relevant (block 1204) to a type of task, for which the machine learning model is to be trained. Task examples include classification, natural language processing, generative artificial intelligence, recommendation engines, reinforcement learning, clustering, and so forth. To do so, the machine learning system collects the training data based on the identified features and/or filters the training data based on the identified features after collection. The training data is then utilized to train a machine learning model.

In order to train the machine learning model in the illustrated example, the machine learning model is first initialized (block 1206). Initialization of the machine learning model includes selecting a model architecture (block 1208) to be trained. Examples of model architectures include neural networks, convolutional neural networks (CNNs), long short-term memory (LSTM) neural networks, generative adversarial networks (GANs), decision trees, support vector machines, linear regression, logistic regression, Bayesian networks, random forest learning, dimensionality reduction algorithms, boosting algorithms, deep learning neural networks, etc.

A loss function is also selected (block 1210). The loss function is utilized to measure a difference between an output of the machine learning model (i.e., predictions) and target values (e.g., as expressed by the training data) to be used to train the machine learning model. Additionally, an optimization algorithm is selected (1212) that is to be used in conjunction with the loss function to optimize parameters of the machine learning model during training, examples of which include gradient descent, stochastic gradient descent (SGD), and so forth.

Initialization of the machine learning model further includes setting initial values of the machine learning model (block 1214) examples of which includes initializing weights and biases of nodes to improve efficiency in training and computational resources consumption as part of training. Hyperparameters are also set that are used to control training of the machine learning model, examples of which include regularization parameters, model parameters (e.g., a number of layers in a neural network), learning rate, batch sizes selected from the training data, and so on. The hyperparameters are set using a variety of techniques, including use of a randomization technique, through use of heuristics learned from other training scenarios, and so forth.

The machine learning model is then trained using the training data (block 1218) by the machine learning system. A machine learning model refers to a computer representation that can be tuned (e.g., trained and retrained) based on inputs of the training data to approximate unknown functions. In particular, the term machine learning model can include a model that utilizes algorithms (e.g., using the model architectures described above) to learn from, and make predictions on, known data by analyzing training data to learn and relearn to generate outputs that reflect patterns and attributes expressed by the training data.

Examples of training types include supervised learning that employs labeled data, unsupervised learning that involves finding an underlying structures or patterns within the training data, reinforcement learning based on optimization functions (e.g., rewards and/or penalties), use of nodes as part of “deep learning,” and so forth. The machine learning model, for instance, is configurable as including a plurality of nodes that collectively form a plurality of layers. The layers, for instance, are configurable to include an input layer, an output layer, and one or more hidden layers. Calculations are performed by the nodes within the layers through the hidden states through a system of weighted connections that are “learned” during training, e.g., through use of the selected loss function and backpropagation to optimize performance of the machine learning model to perform an associated task.

As part of training the machine learning model, a determination is made as to whether a stopping criterion is met (decision block 1220), i.e., which is used to validate the machine learning model. The stopping criterion is usable to reduce overfitting of the machine learning model, reduce computational resource consumption, and promote an ability of the machine learning model to address previously unseen data, i.e., that is not included specifically as an example in the training data. Examples of a stopping criterion include but are not limited to a predefined number of epochs, validation loss stabilization, achievement of a performance improvement threshold, whether a threshold level of accuracy has been met, or based on performance metrics such as precision and recall. If the stopping criterion has not been met (“no” from decision block 1220), the procedure 1200 continues training of the machine learning model using the training data (block 1218) in this example.

If the stopping criterion is met (“yes” from decision block 1620), the trained machine learning model is then utilized to generate an output based on subsequent data (block 1222). The trained machine learning model, for instance, is trained to perform a task as described above and therefore once trained is configured to perform that task based on subsequent data received as an input and processed by the machine learning model.

FIG. 13 shows an example of a method 1300 training a diffusion model according to aspects of the present disclosure. In some embodiments, the method 1300 describes an operation of the training component 1525 described for configuring the image generation model 1515 as described with reference to FIG. 15. According to some aspects, FIG. 13 describes an operation of training one or more LoRA layers of the image generation model using weights of pre-trained layers of the image generation model to perform a reverse diffusion process.

In some examples, these operations are performed by a system including a processor executing a set of codes to control functional elements of an apparatus, such as the guided diffusion model described in FIG. 6.

Additionally or alternatively, certain processes of method 1300 may be performed using special-purpose hardware. Generally, these operations are performed according to the methods and processes described in accordance with aspects of the present disclosure. In some cases, the operations described herein are composed of various substeps, or are performed in conjunction with other operations.

At operation 1305, the user initializes an untrained model. Initialization can include defining the architecture of the model and establishing initial values for the model parameters. In some cases, the initialization can include defining hyper-parameters such as the number of layers, the resolution and channels of each layer blocks, the location of skip connections, and the like.

At operation 1310, the system adds noise to a training image using a forward diffusion process in N stages. In some cases, the forward diffusion process is a fixed process where Gaussian noise is successively added to an image. In latent diffusion models, the Gaussian noise may be successively added to features in a latent space.

At operation 1315, the system at each stage n, starting with stage N, a reverse diffusion process is used to predict the image or image features at stage n−1. For example, the reverse diffusion process can predict the noise that was added by the forward diffusion process, and the predicted noise can be removed from the image to obtain the predicted image. In some cases, an original image is predicted at each stage of the training process.

At operation 1320, the system compares predicted image (or image features) at stage n−1 to an actual image (or image features), such as the image at stage n−1 or the original input image. For example, given observed data x, the diffusion model may be trained to minimize the variational upper bound of the negative log-likelihood −log p_{θ}(x) of the training data.

At operation 1325, the system updates parameters of the model based on the comparison. For example, parameters of a U-Net may be updated using gradient descent. Time-dependent parameters of the Gaussian transitions can also be learned.

Accordingly, a method for training a machine learning model is described. One or more aspects of the method include obtaining a training set including a ground-truth image depicting an object, a lighting input indicating a lighting condition of the object, and a training image depicting the object with a second lighting condition and training, using the training set, an image generation model to generate a synthetic image based on the training image and the lighting input, wherein the synthetic image depicts a foreground object with the lighting condition from the lighting input. In some examples, obtaining the training set includes augmenting a color of the ground-truth image to obtain the training image.

In some examples, training the image generation model includes generating a predicted image based on the training image and the lighting input. Some examples further include computing a reconstruction loss function based on the predicted image and the ground-truth image. Some examples further include updating the parameters of the image generation model based on the reconstruction loss function.

In some examples, updating the parameters of the image generation model includes updating parameters of a low-rank adaptation layer. Some examples of the method further include initializing the image generation model based on a pre-trained image generation model. Some examples further include adding the low-rank adaptation layer to the pre-trained image generation model. In some examples, updating the parameters of the image generation model includes updating parameters of the image generation model corresponding to a color transformation function.

In some examples, these operations are performed by a system including a processor executing a set of codes to control functional elements of an apparatus. Additionally or alternatively, certain processes are performed using special-purpose hardware. Generally, these operations are performed according to the methods and processes described in accordance with aspects of the present disclosure. In some cases, the operations described herein are composed of various substeps, or are performed in conjunction with other operations.

### Image Generation Apparatus

FIG. 14 shows an example of a computing device 1400 according to aspects of the present disclosure. Computing device 1400 is an example of, or includes aspects of, the image generation apparatus described with reference to FIGS. 1, 3-5, and 15. In one aspect, computing device 1400 includes processor(s) 1405, memory subsystem 1410, communication interface 1415, I/O interface 1420, user interface component(s) 1425, and channel 1430.

In some embodiments, computing device 1400 is an example of, or includes aspects of, the image generation model of FIG. 6. In some embodiments, computing device 1400 includes one or more processors 1405 that can execute instructions stored in memory subsystem 1410 to perform image generation.

According to some aspects, computing device 1400 includes one or more processors 1405. In some cases, a processor is an intelligent hardware device, (e.g., a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or a combination thereof. In some cases, a processor is configured to operate a memory array using a memory controller. In other cases, a memory controller is integrated into a processor. In some cases, a processor is configured to execute computer-readable instructions stored in a memory to perform various functions. In some embodiments, a processor includes special purpose components for modem processing, baseband processing, digital signal processing, or transmission processing.

According to some aspects, memory subsystem 1410 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause a processor to perform various functions described herein. In some cases, the memory contains, among other things, a basic input/output system (BIOS) which controls basic hardware or software operation such as the interaction with peripheral components or devices. In some cases, a memory controller operates memory cells. For example, the memory controller can include a row decoder, column decoder, or both. In some cases, memory cells within a memory store information in the form of a logical state.

According to some aspects, communication interface 1415 operates at a boundary between communicating entities (such as computing device 1400, one or more user devices, a cloud, and one or more databases) and channel 1430 and can record and process communications. In some cases, communication interface 1415 is provided to enable a processing system coupled to a transceiver (e.g., a transmitter and/or a receiver). In some examples, the transceiver is configured to transmit (or send) and receive signals for a communications device via an antenna.

According to some aspects, I/O interface 1420 is controlled by an I/O controller to manage input and output signals for computing device 1400. In some cases, I/O interface 1420 manages peripherals not integrated into computing device 1400. In some cases, I/O interface 1420 represents a physical connection or port to an external peripheral. In some cases, the I/O controller uses an operating system such as iOS®, ANDROID®, MS-DOS®, MS-WINDOWS®, OS/2®, UNIX®, LINUX®, or other known operating system. In some cases, the I/O controller represents or interacts with a modem, a keyboard, a mouse, a touchscreen, or a similar device. In some cases, the I/O controller is implemented as a component of a processor. In some cases, a user interacts with a device via I/O interface 1420 or via hardware components controlled by the I/O controller.

According to some aspects, user interface component(s) 1425 enable a user to interact with computing device 1400. In some cases, user interface component(s) 1425 include an audio device, such as an external speaker system, an external display device such as a display screen, an input device (e.g., a remote-control device interfaced with a user interface directly or through the I/O controller), or a combination thereof. In some cases, user interface component(s) 1425 include a GUI.

FIG. 15 shows an example of an image generation apparatus 1500 according to aspects of the present disclosure. Image generation apparatus 1500 is an example of, or includes aspects of, the corresponding element described with reference to FIGS. 1, 3-5, and 14. Image generation apparatus 1500 may include an example of, or aspects of, the guided diffusion model described with reference to FIG. 6 and the U-Net described with reference to FIG. 7. In some embodiments, image generation apparatus 1500 includes processor unit 1505, memory unit 1510, image generation model 1515, I/O module 1520, and training component 1525. Training component 1525 updates parameters of the image generation model 1515 stored in memory unit 1510. In some examples, the training component 1525 is located outside the image generation apparatus 1500.

Processor unit 1505 includes one or more processors. A processor is an intelligent hardware device, such as a general-purpose processing component, a digital signal processor (DSP), a central processing unit (CPU), a graphics processing unit (GPU), a microcontroller, an application specific integrated circuit (ASIC), a field programmable gate array (FPGA), a programmable logic device, a discrete gate or transistor logic component, a discrete hardware component, or any combination thereof.

In some cases, processor unit 2505 is configured to operate a memory array using a memory controller. In other cases, a memory controller is integrated into processor unit 1505. In some cases, processor unit 1505 is configured to execute computer-readable instructions stored in memory unit 1510 to perform various functions. In some aspects, processor unit 1505 includes special purpose components for modem processing, baseband processing, digital signal processing, or transmission processing. According to some aspects, processor unit 1505 comprises one or more processors 1405 described with reference to FIG. 14.

Memory unit 1510 includes one or more memory devices. Examples of a memory device include random access memory (RAM), read-only memory (ROM), or a hard disk. Examples of memory devices include solid state memory and a hard disk drive. In some examples, memory is used to store computer-readable, computer-executable software including instructions that, when executed, cause at least one processor of processor unit 1505 to perform various functions described herein.

In some cases, memory unit 1510 includes a basic input/output system (BIOS) that controls basic hardware or software operations, such as an interaction with peripheral components or devices. In some cases, memory unit 1510 includes a memory controller that operates memory cells of memory unit 1510. For example, the memory controller may include a row decoder, column decoder, or both. In some cases, memory cells within memory unit 1510 store information in the form of a logical state. According to some aspects, memory unit 1510 is an example of the memory subsystem 1410 described with reference to FIG. 14.

According to some aspects, image generation apparatus 1500 uses one or more processors of processor unit 1505 to execute instructions stored in memory unit 1510 to perform functions described herein. For example, the image generation apparatus 1500 may perform operations comprising obtaining an input image and an input prompt, wherein the input image depicts an object and the input prompt describes a lighting condition for the object; generating, using a low-rank adaptation layer of an image generation model, relighted image features based on the input image and the input prompt, wherein the relighted image features represent the object with the lighting condition; and generating, using the image generation model, a synthetic image based on the relighted image features, wherein the synthetic image depicts the object with the lighting condition.

The memory unit 1510 may include an image generation model 1515 trained to generate a synthetic image based on a training image and a lighting input. For example, after training, the image generation model 1515 may perform inferencing operations as described with reference to FIGS. 8-10 to generate a synthetic image based on relighted image features, where the synthetic image depicts the object with the lighting condition. Image generation model 1515 is an example of, or includes aspects of, the corresponding element described with reference to FIGS. 1, 3, and 5.

In some embodiments, the image generation model 1515 is an artificial neural network (ANN) such as the guided diffusion model described with reference to FIG. 6 and the U-Net described with reference to FIG. 7. An ANN can be a hardware component or a software component that includes connected nodes (i.e., artificial neurons) that loosely correspond to the neurons in a human brain. Each connection, or edge, transmits a signal from one node to another (like the physical synapses in a brain). When a node receives a signal, it processes the signal and then transmits the processed signal to other connected nodes.

ANNs have numerous parameters, including weights and biases associated with each neuron in the network, which control the degree of connection between neurons and influence the neural network's ability to capture complex patterns in data. These parameters, also known as model parameters or model weights, are variables that determine the behavior and characteristics of a machine learning model.

In some cases, the signals between nodes comprise real numbers, and the output of each node is computed by a function of its inputs. For example, nodes may determine their output using other mathematical algorithms, such as selecting the max from the inputs as the output, or any other suitable algorithm for activating the node. Each node and edge are associated with one or more node weights that determine how the signal is processed and transmitted. In some cases, nodes have a threshold below which a signal is not transmitted at all. In some examples, the nodes are aggregated into layers.

The parameters of the image generation model 1515 can be organized into layers. Different layers perform different transformations on their inputs. The initial layer is known as the input layer and the last layer is known as the output layer. In some cases, signals traverse certain layers multiple times. A hidden (or intermediate) layer includes hidden nodes and is located between an input layer and an output layer. Hidden layers perform nonlinear transformations of inputs entered into the network. Each hidden layer is trained to produce a defined output that contributes to a joint output of the output layer of the ANN. Hidden representations are machine-readable data representations of an input that are learned from hidden layers of the ANN and are produced by the output layer. As the understanding of the ANN of the input improves as the ANN is trained, the hidden representation is progressively differentiated from earlier iterations.

Training component 1525 may train the image generation model 1515. For example, parameters of the image generation model 1515 can be learned or estimated from training data and then used to make predictions or perform tasks based on learned patterns and relationships in the data. In some examples, the parameters are adjusted during the training process to minimize a loss function or maximize a performance metric (e.g., as described with reference to FIGS. 11-13). The goal of the training process may be to find optimal values for the parameters that allow the image generation model 1515 to make accurate predictions or perform well on the given task.

Accordingly, the node weights can be adjusted to improve the accuracy of the output (i.e., by minimizing a loss which corresponds in some way to the difference between the current result and the target result). The weight of an edge increases or decreases the strength of the signal transmitted between nodes. For example, during the training process, an algorithm adjusts machine learning parameters to minimize an error or loss between predicted outputs and actual targets according to optimization techniques like gradient descent, stochastic gradient descent, or other optimization algorithms. Once the machine learning parameters are learned from the training data, the image generation model 1515 can be used to make predictions on new, unseen data (i.e., during inference).

I/O module 1520 receives inputs from and transmits outputs of the image generation apparatus 1500 to other devices or users. For example, I/O module 1520 receives inputs for the image generation model 1515 and transmits outputs of the image generation model 1515. According to some aspects, I/O module 1520 is an example of the I/O interface 1420 described with reference to FIG. 14.

According to some aspects, training component 1525 comprises executable code (e.g., software) stored in memory unit 1510, firmware, one or more hardware circuits, or a combination thereof.

Accordingly, a system and apparatus for image relighting using machine learning is described. One or more aspects of the system and apparatus include a memory component and a processing device coupled to the memory component, the processing device configured to perform operations comprising: obtaining an input image and an input prompt, wherein the input image depicts an object and the input prompt describes a lighting condition for the object; generating, using a low-rank adaptation layer of an image generation model, relighted image features based on the input image and the input prompt, wherein the relighted image features represent the object with the lighting condition; and generating, using the image generation model, a synthetic image based on the relighted image features, wherein the synthetic image depicts the object with the lighting condition.

In some aspects, the low-rank adaptation layer comprises image relighting parameters stored in the memory component. In some aspects, the image generation model further comprises color transformation parameters trained to perform a color transformation function.

The description and drawings described herein represent example configurations and do not represent all the implementations within the scope of the claims. For example, the operations and steps may be rearranged, combined or otherwise modified. Also, structures and devices may be represented in the form of block diagrams to represent the relationship between components and avoid obscuring the described concepts. Similar components or features may have the same name but may have different reference numbers corresponding to different figures.

Some modifications to the disclosure may be readily apparent to those skilled in the art, and the principles defined herein may be applied to other variations without departing from the scope of the disclosure. Thus, the disclosure is not limited to the examples and designs described herein, but is to be accorded the broadest scope consistent with the principles and novel features disclosed herein.

The described methods may be implemented or performed by devices that include a general-purpose processor, a digital signal processor (DSP), an application specific integrated circuit (ASIC), a field programmable gate array (FPGA) or other programmable logic device, discrete gate or transistor logic, discrete hardware components, or any combination thereof. A general-purpose processor may be a microprocessor, a conventional processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Thus, the functions described herein may be implemented in hardware or software and may be executed by a processor, firmware, or any combination thereof. If implemented in software executed by a processor, the functions may be stored in the form of instructions or code on a computer-readable medium.

Computer-readable media includes both non-transitory computer storage media and communication media including any medium that facilitates transfer of code or data. A non-transitory storage medium may be any available medium that can be accessed by a computer. For example, non-transitory computer-readable media can comprise random access memory (RAM), read-only memory (ROM), electrically erasable programmable read-only memory (EEPROM), compact disk (CD) or other optical disk storage, magnetic disk storage, or any other non-transitory medium for carrying or storing data or code.

Also, connecting components may be properly termed computer-readable media. For example, if code or data is transmitted from a website, server, or other remote source using a coaxial cable, fiber optic cable, twisted pair, digital subscriber line (DSL), or wireless technology such as infrared, radio, or microwave signals, then the coaxial cable, fiber optic cable, twisted pair, DSL, or wireless technology are included in the definition of medium. Combinations of media are also included within the scope of computer-readable media.

In this disclosure and the following claims, the word “or” indicates an inclusive list such that, for example, the list of X, Y, or Z means X or Y or Z or XY or XZ or YZ or XYZ. Also the phrase “based on” is not used to represent a closed set of conditions. For example, a step that is described as “based on condition A” may be based on both condition A and condition B. In other words, the phrase “based on” shall be construed to mean “based at least in part on.” Also, the words “a” or “an” indicate “at least one.”

1. A method for image generation, comprising:
obtaining an input image and an input prompt, wherein the input image depicts an object and the input prompt describes a lighting condition for the object;
generating, using a low-rank adaptation layer of an image generation model, relighted image features based on the input image and the input prompt, wherein the relighted image features represent the object with the lighting condition; and
generating, using the image generation model, a synthetic image based on the relighted image features, wherein the synthetic image depicts the object with the lighting condition.

2. The method of claim 1, wherein:
the lighting condition includes at least one of a color, a brightness, a shadow, and a reflective property.

3. The method of claim 1, wherein generating the relighted image features comprises:
encoding the input prompt to obtain a prompt embedding, wherein the relighted image features are based on the prompt embedding.

4. The method of claim 3, wherein:
the input prompt comprises a text prompt or an image prompt.

5. The method of claim 1, wherein:
the image generation model is trained based on a pre-trained image generation model by adding the low-rank adaptation layer to the pre-trained image generation model.

6. The method of claim 1, wherein generating the relighted image features comprises:
encoding the input image to obtain an image embedding, wherein the relighted image features are based on the image embedding.

7. The method of claim 1, wherein generating the synthetic image comprises:
computing a color transformation function based on the relighted image features, wherein the synthetic image is based on the color transformation function.

8. The method of claim 7, further comprising:
predicting one or more color parameters based on the color transformation function, wherein the synthetic image is based on the one or more color parameters.

9. The method of claim 1, wherein generating the synthetic image comprises:
generating a background of the synthetic image, wherein content of the background is described by the input prompt.

10. The method of claim 9, further comprising:
generating the background of the synthetic image based on an editing mask.

11. The method of claim 1, wherein generating the synthetic image comprises:
obtaining a noise map; and
denoising the noise map based on the input prompt to obtain the synthetic image.

12. A non-transitory computer readable medium storing code for image processing, the code comprising instructions that, when executed by at least one processor, cause the at least one processor to perform operations comprising:
obtaining an input image and an input prompt that describes a lighting condition;
generating, an image generation model, relighted image features based on the input image and the input prompt;
computing a color transformation function based on the relighted image features; and
generating, using the image generation model, a synthetic image based on the input image and the color transformation, wherein the synthetic image depicts the input image with the lighting condition.

13. The non-transitory computer readable medium of claim 12, the operations further comprising:
predicting one or more color parameters based on the color transformation function, wherein the synthetic image is based on the one or more color parameters.

14. The non-transitory computer readable medium of claim 12, wherein:
the relighted image features are generated using a low-rank adaptation layer of the image generation model.

15. The non-transitory computer readable medium of claim 14, wherein:
the image generation model is trained based on a pre-trained image generation model by adding the low-rank adaptation layer to the pre-trained image generation model.

16. The non-transitory computer readable medium of claim 15, wherein:
the image generation model is trained based on a reconstruction loss.

17. The non-transitory computer readable medium of claim 12, wherein generating the relighted image features comprises:
encoding the input image to obtain an image embedding, wherein the relighted image features are based on the image embedding.

18. A system for image generation, comprising:
a memory component; and
a processing device coupled to the memory component, the processing device configured to perform operations comprising:
obtaining an input image and an input prompt, wherein the input image depicts an object and the input prompt describes a lighting condition for the object;
generating, using a low-rank adaptation layer of an image generation model, relighted image features based on the input image and the input prompt, wherein the relighted image features represent the object with the lighting condition; and
generating, using the image generation model, a synthetic image based on the relighted image features, wherein the synthetic image depicts the object with the lighting condition.

19. The system of claim 18, wherein:
the low-rank adaptation layer comprises image relighting parameters stored in the memory component.

20. The system of claim 18, wherein:
the image generation model further comprises color transformation parameters trained to perform a color transformation function.
